(19) United States
(12) Patent Application Publication
(10) Pub. No.: US 2017/0194704 A1
(43) Pub. Date: Jul. 6, 2017

(54) ANTENNA HAVING A BEAM INTERRUPTER FOR INCREASED THROUGHPUT

(71) Applicant: John Mezzalingua Associates, LLC, Liverpool, NY (US)

(72) Inventors: Shawn M. Chawgo, Cicero, NY (US); David M. Sobczak, Kingsville, MD (US)

(73) Assignee: John Mezzalingua Associates, LLC, Liverpool, NY (US)

(21) Appl. No.: 15/395,860

(22) Filed: Dec. 30, 2016

Related U.S. Application Data
(60) Provisional application No. 62/274,851, filed on Jan. 5, 2016.

(51) Int. Cl. H01Q 3/06; H01Q 1/42; H01Q 3/04

(52) U.S. Cl. CPC H01Q 3/06; H01Q 3/04; H01Q 1/42

(57) ABSTRACT

A telecommunications antenna including a conductive ground plane, at least one radiator, and Electromagnetic Energy (EME) interrupter. The radiator is disposed in combination with the conductive ground plane and produces a beam pattern indicative of the performance/throughput of the radiator. The EME interrupter electrically connects to the conductive ground plane and is operative to electrically inhibit the transmission/reception of electromagnetic energy within a sector of the beam pattern. In one embodiment, the EME interrupter inhibits the transmission of energy within a sector of between about one degree (1°) to about twenty degrees (20°).

### CROSS-REFERENCE TO RELATED APPLICATION

This application is a non-provisional patent application, and claims the benefit and priority of U.S. Provisional Patent Application Ser. No. 62/274,851 filed on Jan. 5, 2016 and is related to U.S. patent application Ser. No. 14/497,575, entitled “INTERFERENCE REDUCTION SYSTEM FOR ONE OR MORE ANTENNAS” filed on Sep. 26, 2014. The entire contents of such applications are hereby incorporated by reference.

### BACKGROUND

Telecommunications antennas facilitate the exchange of data to allow subscribers of mobile devices to communicate wirelessly, even in some of the most remote locations. In addition to being mounted atop dedicated cell phone towers, such antennas are also mounted on rooftops, tall buildings, and sports stadiums. The antennas are strategically located to provide adequate coverage in areas which are light or dense in terms of subscriber population.

One difficulty commonly encountered by mobile device subscribers relates to interference, and the quality of the cell phone signal as a consequence of such interference. For example, antennas can interfere with each other by the cancellation, amplification, or distortion of the respective beam patterns generated by each. Objects in and around the antennas can act as reflectors which receive radiation from one or more antennas and reflect radiation toward another group of antennas. Antenna patterns can overlap such that the radiated energy can be additive/amplified or subtractive/degraded. For example, a low strength signal, i.e., wherein the overlap effects cancellation or degradation of the signal, can result in poor connections, intermittent reception, and dropped calls.

Businesses operating sports stadiums often do not know when and/or which mobile phone users are experiencing problems due to antenna interference. Consequently, stadium attendees can be very dissatisfied with the efficacy of their mobile phone service. Upon identifying the source of such interference, the business owner must undertake extensive efforts to address/resolve the problem. For example, a technician may have a need to access a multitude of individual antennas each requiring separate and precise placement/orientation to reduce the interference and improve the signal quality. Upon finding a suitable orientation, the technician fixes the orientation/position of each antenna. Should however, other changes be made to the surrounding environment, e.g., the construction of a bridge/boom for supporting a camera, yet other antenna manipulation steps may be required to mitigate passive intermodulation and interference caused by such environmental changes.

Therefore, there is a need to overcome, or otherwise lessen the effects of, the disadvantages and shortcomings described above.

### SUMMARY

According to one embodiment, a telecommunications antenna is provided including a conductive ground plane, at least one radiator, and Electromagnetic Energy (EME) interrupter. The radiator is disposed in combination with the conductive ground plane and produces a beam pattern indicative of the performance/throughput of the radiator. The EME interrupter electrically connects to the conductive ground plane and is operative to electrically inhibit the transmission/reception of electromagnetic energy within a sector of the beam pattern. In one embodiment, the EME interrupter inhibits the transmission of energy within a sector of between about one degree (1°) to about twenty degrees (20°).

In another embodiment, a method of controlling an electromagnetic antenna is provided comprising the steps of operating a Radio Frequency (RF) radiator by transmitting and receiving Electromagnetic Energy (EME) energy about a conductive ground plane, sensing a beam pattern produced by the radiator about an axis of symmetry normal to the conductive ground plane, the beam pattern being indicative of the performance of the radiator's signal strength, and interrupting the Electromagnetic Energy (EME) transmitted/received within a sector of the beam pattern.

Additional features and advantages of the present disclosure are described in, and will be apparent from, the following Brief Description of the Drawings

### BRIEF DESCRIPTION OF THE DRAWINGS

Additional features and advantages of the present disclosure are described in, and will be apparent from, the following Brief Description of the Drawings and Detailed Description.

FIG. 1 is a schematic diagram illustrating an example of one embodiment of an outdoor wireless communication network.

FIG. 2 is a schematic diagram illustrating an example of one embodiment of an indoor wireless communication network.

FIG. 3 is an isometric view of one embodiment of a base station illustrating a tower and ground shelter.

FIG. 4 is an isometric view of one embodiment of a tower.

FIG. 5 is an isometric view of one embodiment of an interface port.

FIG. 6 is an isometric view of another embodiment of an interface port.

FIG. 7 is an isometric view of yet another embodiment of an interface port.

FIG. 8 is an isometric, cut-away view of one embodiment of a cable connector and cable.

FIG. 9 is an isometric, exploded view of one embodiment of a cable assembly having a cover.

FIG. 10 is an isometric view of one embodiment of a cable connector covered by a cover.

FIG. 11 is a schematic diagram of one embodiment of an environment having one embodiment of the interference reduction system.

FIG. 12 is a schematic diagram of another embodiment of an environment having another embodiment of the interference reduction system.

FIG. 13 is a schematic diagram of one embodiment of the interference reduction system and a plurality of embodiments of the antenna control module.

FIG. 14 is a schematic diagram of one embodiment of a DAS antenna unit, one embodiment of a remote radio head or unit and one embodiment of a DAS manager.

FIG. 15 is one example of a polar plot of an example of a radiation pattern of an antenna.

FIG. 16 is one example of a polar plot of an example of a radiation pattern of a DAS antenna unit, illustrating the interference reduction system's effect of aligning a null with directions or lines of interference from multiple interference sources.

FIG. 17 is a graph illustrating an example of the decrease in interference achieved by one embodiment of the interference reduction system.

FIG. 18 is a perspective view of a telecommunications antenna mounted internally of a canister housing which is integrated within a ceiling structure of a conventional office or commercial building.

FIG. 19 is a perspective view of the internal components of the telecommunications antenna including a conductive ground plane, a pair of broadband radiators mounting to the conductive ground plane operative to produce a beam pattern, and an ElectroMagnetic Energy (EME) interrupter electrically connected to the conductive ground plane and operative to electrically inhibit the transmission/reception of electromagnetic energy within a sector of the beam pattern.

FIG. 20 is a top view of the telecommunications antenna system shown in FIG. 19.

FIG. 21 depicts beam patterns produced by a pair of broadband radiators both with and without the use/introduction of an EME interrupter.

### DETAILED DESCRIPTION

1. Overview

1.1 Wireless Communication Networks

In one embodiment, wireless communications are operable based on a network switching subsystem (“NSS”). The NSS includes a circuit-switched core network for circuit-switched phone connections. The NSS also includes a general packet radio service architecture which enables mobile networks, such as 2G, 3G and 4G mobile networks, to transmit Internet Protocol (“IP”) packets to external networks such as the Internet. The general packet radio service architecture enables mobile phones to have access to services such as Wireless Application Protocol (“WAP”), Multimedia Messaging Service (“MSS”) and the Internet.

A service provider or carrier operates a plurality of centralized mobile telephone switching offices (“MTSOs”). Each MTSO controls the base stations within a select region or cell surrounding the MTSO. The MTSOs also handle connections to the Internet and phone connections.

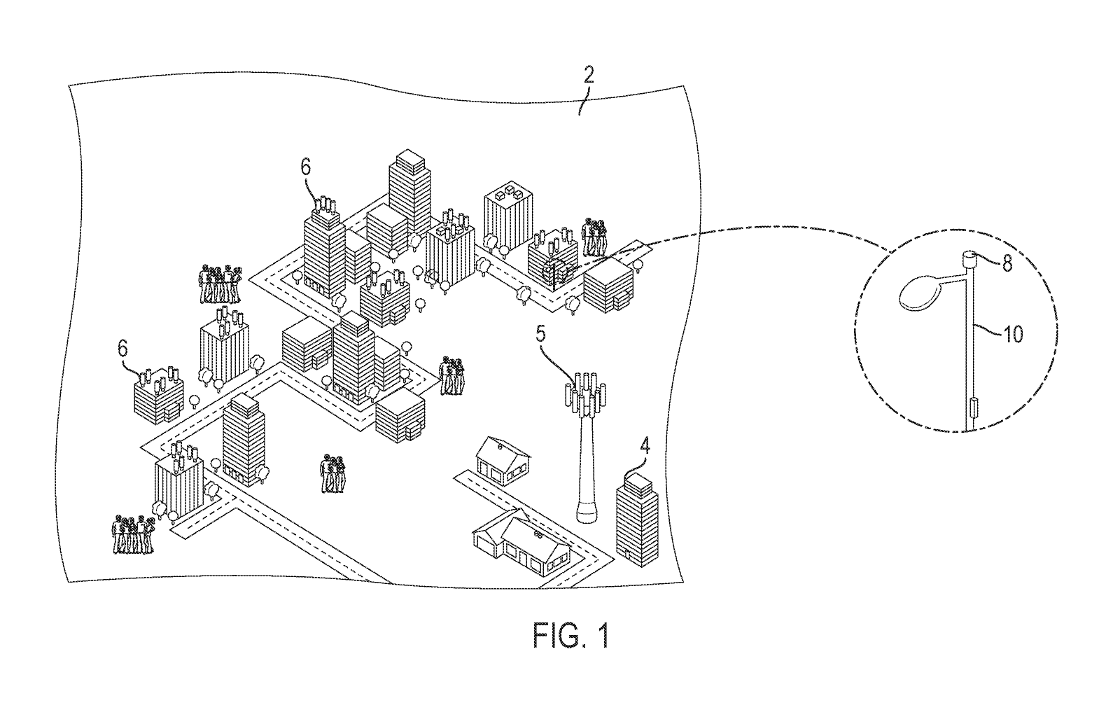

Referring to FIG. 1, an outdoor wireless communication network 2 includes a cell site or cellular base station 4. The base station 4, in conjunction with a cell tower 5, serves communication devices, such as mobile phones, in a defined area surrounding the base station 4. The cell tower 5 also communicates with the macro antennas 6 on building tops as well as micro antennas 8 mounted to, for example, street lamps 10.

The cell size depends upon the type of wireless network. For example, a macro cell can have a base station antenna installed on a tower or a building above the average rooftop level, such as the macro antennas 5 and 6. A micro cell can have an antenna installed at a height below the average rooftop level, often suitable for urban environments, such as the street lamp-mounted micro antenna 8. A pico cell is a relatively small cell often suitable for indoor use.

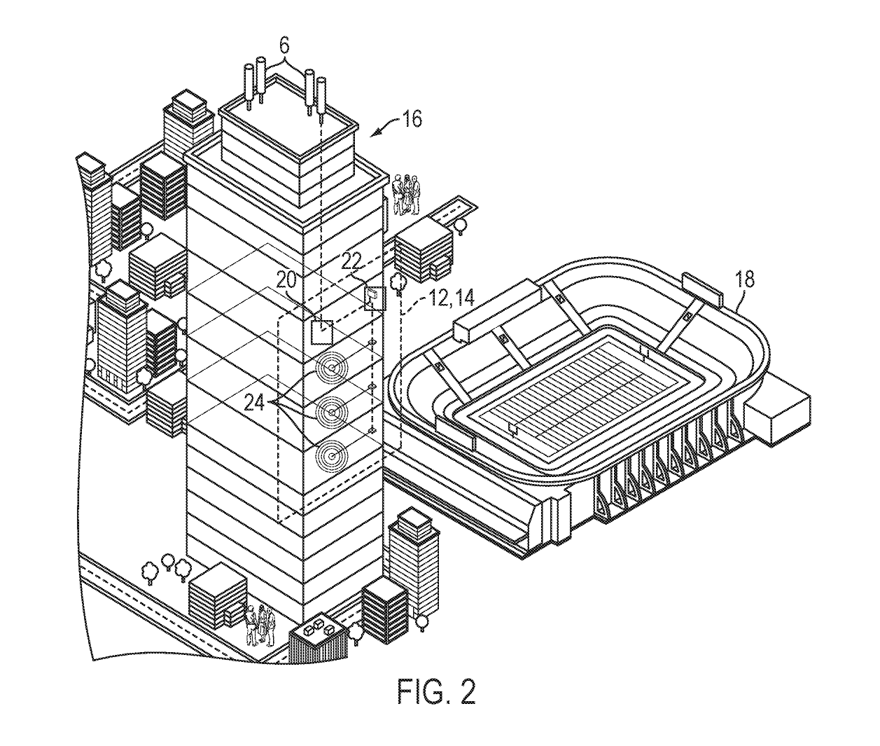

As illustrated in FIG. 2, an indoor wireless communication network 12 includes an active distributed antenna system (“DAS”) 14. The DAS 14 can, for example, be installed in a high rise commercial office building 16, a sports stadium 18 or a shopping mall. In one embodiment, the DAS 14 includes macro antennas 6 coupled to a radio frequency (“RF”) repeater 20. The macro antennas 6 receive signals from a nearby base station. The RF repeater 20 amplifies and repeats the received signals. The RF repeater 20 is coupled to a DAS master unit or DAS manager 22 which, in turn, is coupled to a plurality of remote antenna units 24 distributed throughout the building 16. Depending upon the embodiment, the DAS manager 22 can control and manage over one hundred remote antenna units 24 in a building 16. In one embodiment, the DAS manager 22 includes a server having one or more databases and data processors. In operation, the DAS manager 22 is programmed to control and manage the coverage and performance of the remote antenna units 24 based on the number of repeated signals fed by the repeater 20. It should be appreciated that a technician can remotely adjust and control the DAS manager 22 through a Local Area Network (LAN) connection or wireless modem.

Depending upon the embodiment, the RF repeater 20 can be an analog repeater that amplifies all received signals, or the RF repeater 20 can be a digital repeater. In one embodiment, the digital repeater includes a processor and a memory device or data storage device. The data storage device stores logic in the form of computer-readable instructions. The processor executes the logic to filter or clean the received signals before repeating the signals. In one embodiment, the digital repeater does not need to receive signals from an external antenna, but rather, has a built-in antenna located within its housing.

1.2 Base Stations

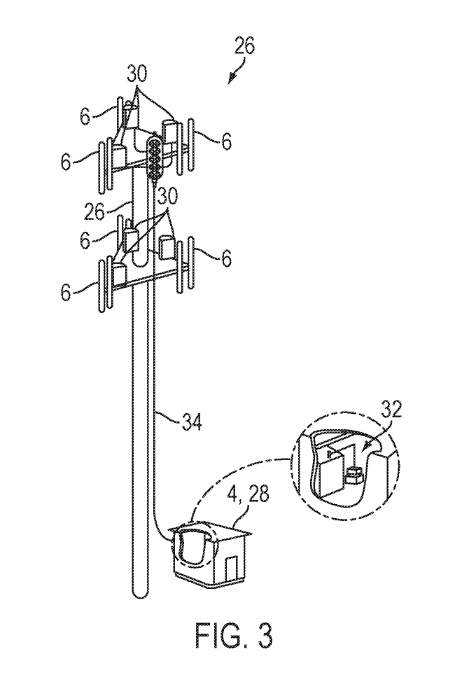

In one embodiment illustrated in FIG. 3, the base station 4 includes a tower 26 and a ground shelter 28 next to the tower 26. In this example, a plurality of exterior antennas 6 and remote radio heads 30 are mounted to the tower 26. The shelter 28 encloses base station equipment 32. Depending upon the embodiment, the base station equipment 32 includes electrical hardware operable to transmit and receive radio signals and to encrypt and decrypt communications with the MTSO. The base station equipment 32 also includes power supply units and equipment for powering and controlling the antennas and other devices mounted to the tower 26.

In one embodiment, a distribution line 34, such as coaxial cable or fiber optic cable, distributes signals that are exchanged between the base station equipment 32 and the remote radio heads 30. Each remote radio head 30 is operatively coupled to, and mounted adjacent to, a group of associated macro antennas 6. Each remote radio head 30 manages the distribution of signals between its associated macro antennas 6 and the base station equipment 30. In one embodiment, the remote radio heads 30 extend the coverage and efficiency of the macro antennas 6. Each remote radio head 30, in one embodiment, has RF circuitry, analog-to-digital/digital-to-analog converters and up/down converters, including a transceiver.

1.3 Antennas

The antennas, such as macro antennas 6, micro antennas 8 and remote antenna units 24, are operable to receive signals from communication devices and send signals to the communication devices. Depending upon the embodiment, the antennas can be of different types, including, but not limited to, directional antennas, omni-directional antennas, isotropic antennas, dish-shaped antennas, and microwave antennas. Directional antennas can improve reception in higher traffic areas, along highways, and inside buildings like stadiums and arenas. Based upon applicable laws and legal regulations, a service provider may operate omni-directional cell tower signals up to a maximum power, such as 100 watts, while the service provider may operate directional cell tower signals up to a higher maximum of effective radiated power (“ERP”), such as 500 watts.

An omni-directional antenna is operable to radiate radio wave power uniformly, or substantially uniformly, in all directions in one plane. The radiation pattern can be similar to a doughnut shape where the antenna is at the center of the doughnut. The radial distance from the center represents the power radiated in that direction. The power radiated is maximum in horizontal directions, dropping to zero directly above and below the antenna.

An isotropic antenna is operable to radiate equal, or substantially equal, power in all directions and has a spherical radiation pattern. Omni-directional antennas, when properly mounted, can save energy in comparison to isotropic antennas. For example, since their radiation drops off with elevation angle, little radio energy is aimed into the sky or down toward the earth where it could be wasted. In contrast to omni-directional antennas, isotropic antennas can waste such upwardly and downwardly aimed energy.

In one embodiment, the antenna has: (a) an antenna support or frame; (b) a conductor, dipole, radiator or radiator array supported by the antenna frame; (c) a transmitting data port, a receiving data port, or a transceiver data port; (d) a motor; (e) a housing or enclosure that covers the motor and the radiator array; and (f) a drive assembly or drive mechanism that couples the motor to the antenna frame. Depending upon the embodiment, the radiator array can be tiltably, pivotably or rotatably mounted to the antenna frame.

One or more cables connect the antenna to one of the remote radio heads 30, which provides electrical power and motor control signals to the antenna. A technician of a service provider can reposition the antenna by providing desired inputs using the base station equipment 32. For example, if the antenna has poor reception, the technician can enter tilt inputs to change the azimuth or elevation angle of the antenna from the ground without having to climb up to reach the antenna. In one embodiment, the antenna's motor drives the antenna frame to the specified position. In another embodiment, the antenna's motor controls a phase shifter of the antenna, and the phase shifter changes the antenna's beam or radiation pattern to tilt in a different direction. In such embodiment, the antenna does not physically tilt or move, but rather, the radiation pattern is generated in a tilted direction. Depending upon the embodiment, a technician can control the position or orientation of the antenna from the base station, from a distant office or from a land vehicle by providing inputs over the Internet.

1.4 Data Interface Ports

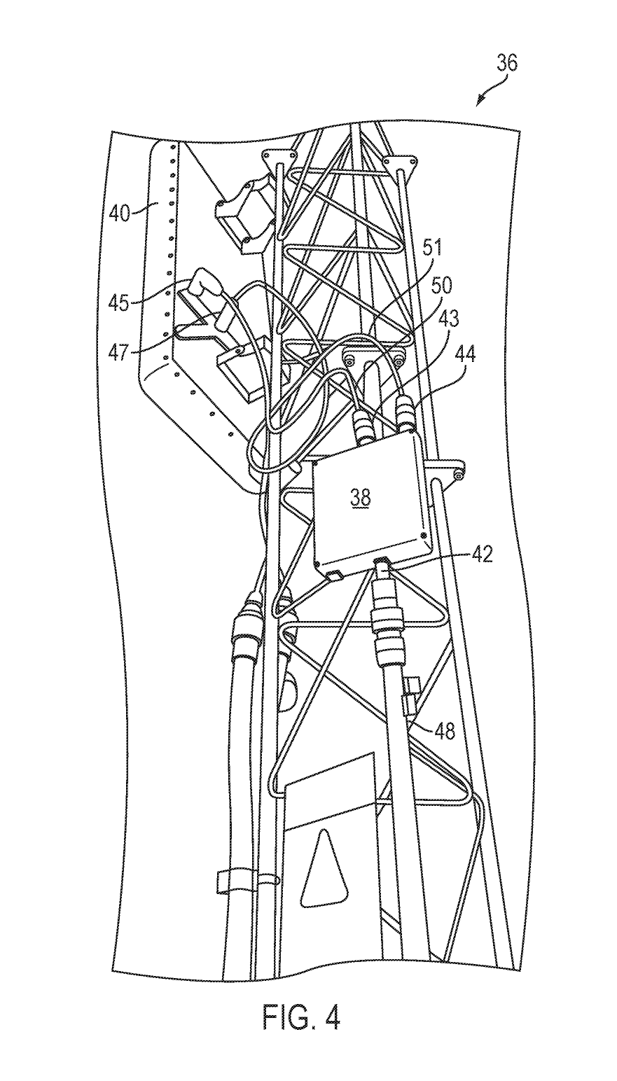

Generally, the networks 2 and 12 include a plurality of wireless network devices, including, but not limited to, the base station equipment 32, one or more radio heads 30, macro antennas 6, micro antennas 8, RF repeaters 20 and remote antenna units 24. As described above, these network devices include data interface ports that couple to connectors of signal-carrying cables, such as coaxial cables and fiber optic cables. In the example illustrated in FIG. 4, the tower 36 supports a radio head 38 and macro antenna 40. The radio head 38 has interface ports 42, 43 and 44 and the macro antenna 40 has antenna ports 45 and 47. In the example shown, the coaxial cable 48 is connected to the radio head interface port 42, while the coaxial cable jumpers 50 and 51 are connected to radio head interface ports 43 and 44, respectively. The coaxial cable jumpers 50 and 51 are also connected to antenna interface ports 45 and 47, respectively.

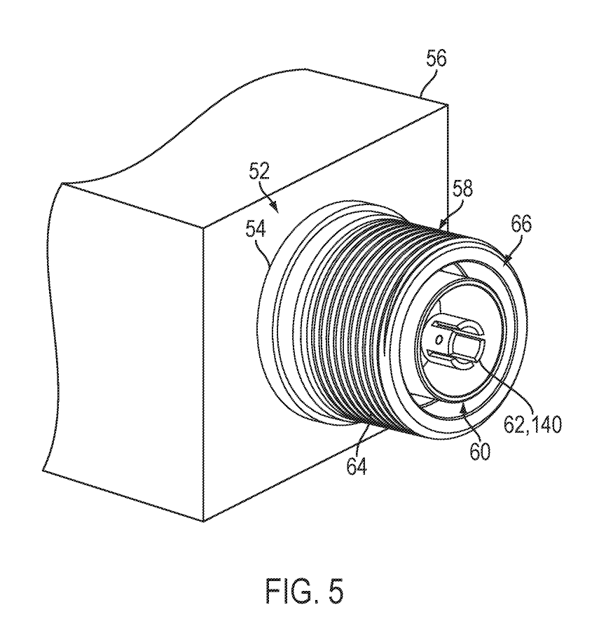

The interface ports of the networks 2 and 12 can have different shapes, sizes and surface types depending upon the embodiment. In one embodiment illustrated in FIG. 5, the interface port 52 has a tubular or cylindrical shape. The interface port 52 includes: (a) a forward end or base 54 configured to abut the network device enclosure, housing or wall 56 of a network device; (b) a coupler engager 58 configured to be engaged with a cable connector's coupler, such as a nut; (c) an electrical ground 60 received by the coupler engager 58; and (d) a signal carrier 62 received by the electrical grounder 60.

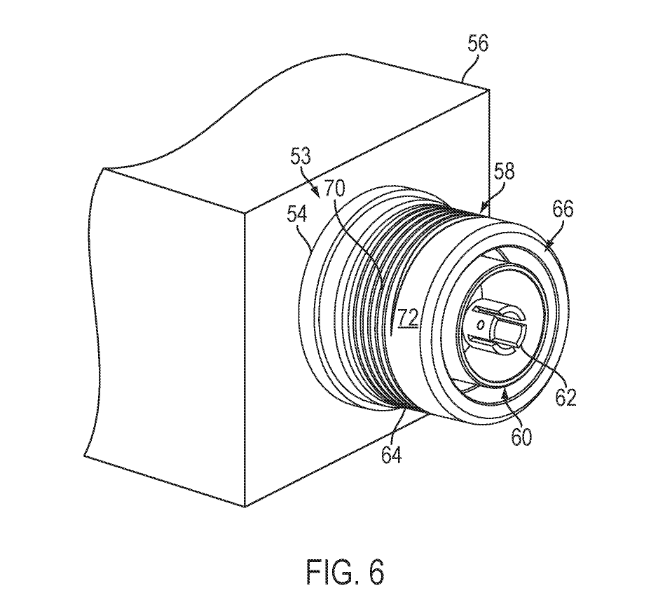

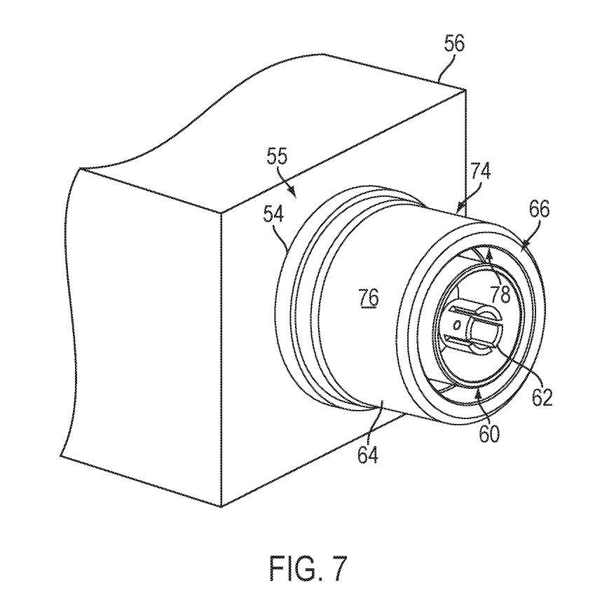

In the illustrated embodiment, the base 54 has a collar shape with a diameter larger than the diameter of the coupler engager 58. The coupler engager 58 is tubular in shape, has a threaded, outer surface 64 and a rearward end 66. The threaded outer surface 64 is configured to threadably mate with the threads of the coupler of a cable connector, such as connector 68 described below. In one embodiment illustrated in FIG. 6, the interface port 53 has a forward section 70 and a rearward section 72 of the coupler engager 62. The forward section 70 is threaded, and the rearward section 72 is non-threaded. In another embodiment illustrated in FIG. 7, the interface port 55 has a coupler engager 74. In this embodiment, the coupler engager 74 is the same as coupler engager 58 except that it has a non-threaded, outer surface 76 and a threaded, inner surface 78. The threaded, inner surface 78 is configured to be inserted over, and threadably engaged with, a cable connector.

Referring to FIGS. 5-8, in one embodiment, the signal carrier 62 is tubular and configured to receive a pin or inner conductor engager 80 of the cable connector 68. Depending upon the embodiment, the signal carrier 62 can have a plurality of fingers 82 which are spaced apart from each other about the perimeter of the signal carrier 80. When the cable inner conductor 84 is inserted into the signal carrier 80, the fingers 82 apply a radial, inward force to the inner conductor 84 to establish a physical and electrical connection with the inner conductor 84. The electrical connection enables data signals to be exchanged between the devices that are in communication with the interface port. In one embodiment, the electrical ground 60 is tubular and configured to mate with a connector ground 86 of the cable connector 68. The connector ground 86 extends an electrical ground path to the ground 64 as described below.

1.5 Cables

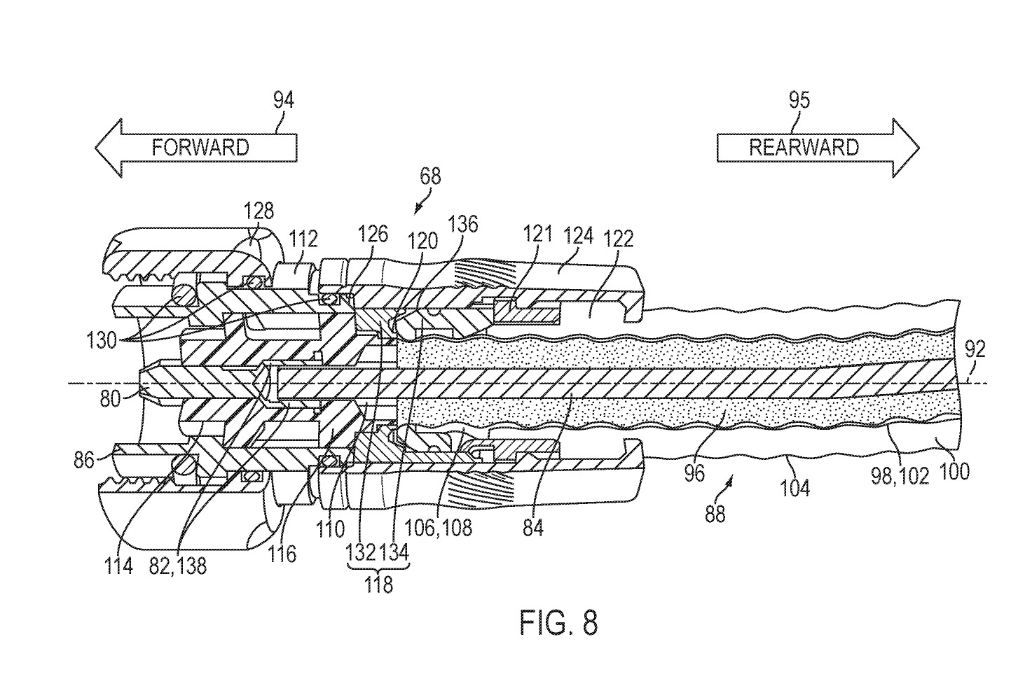

In one embodiment illustrated in FIGS. 4 and 8-10, the networks 2 and 12 include one or more types of coaxial cables 88. In the embodiment illustrated in FIG. 8, the coaxial cable 88 has: (a) a conductive, central wire, tube, strand or inner conductor 84 that extends along a longitudinal axis 92 in a forward direction 94 toward the interface port 56; (b) a cylindrical or tubular dielectric, or insulator 96 that receives and surrounds the inner conductor 84; (c) a conductive tube or outer conductor 98 that receives and surrounds the insulator 96; and (d) a sheath, sleeve or jacket 100 that receives and surrounds the outer conductor 98. In the illustrated embodiment, the outer conductor 98 is corrugated, having a spiral, exterior surface 102. The exterior surface 102 defines a plurality of peaks and valleys to facilitate flexing or bending of the cable 88 relative to the longitudinal axis 92.

To achieve the cable configuration shown in FIG. 8, an assembler/preparer, in one embodiment, takes one or more steps to prepare the cable 90 for attachment to the cable connector 68. In one example, the steps include: (a) removing a longitudinal section of the jacket 104 to expose the bare surface 106 of the outer conductor 108; (b) removing a longitudinal section of the outer conductor 108 and insulator 96 so that a protruding end 110 of the inner conductor 84 extends forward, beyond the recessed outer conductor 108 and the insulator 96, forming a step-shape at the end of the cable 68; and (c) removing or coring-out a section of the recessed insulator 96 so that the forward-most end of the outer conductor 106 protrudes forward of the insulator 96.

In another embodiment not shown, the cables of the networks 2 and 12 include one or more types of fiber optic cables. Each fiber optic cable includes a group of elongated light signal guides or flexible tubes. Each tube is configured to distribute a light-based or optical data signal to the networks 2 and 12.

1.6 Connectors

In the embodiment illustrated in FIG. 8, the cable connector 68 includes: (a) a connector housing or connector body 112; (b) a connector insulator 114 received by, and housed within, the connector body 112; (c) the inner conductor engager 80 received by, and slidably positioned within, the connector insulator 114; (d) a driver 116 configured to axially drive the inner conductor engager 80 into the connector insulator 114 as described below; (e) an outer conductor clamp device or outer conductor clamp assembly 118 configured to clamp, sandwich, and lock onto the end section 120 of the outer conductor 106; (f) a clamp driver 121; (g) a tubular-shaped, deformable, environmental seal 122 that receives the jacket 104; (h) a compressor 124 that receives the seal 122, clamp driver 121, clamp assembly 118, and the rearward end 126 of the connector body 112; (i) a nut, fastener or coupler 128 that receives, and rotates relative to, the connector body 112; and (j) a plurality of O-rings or ring-shaped environmental seals 130. The environmental seals 122 and 130 are configured to deform under pressure so as to fill cavities to block the ingress of environmental elements, such as rain, snow, ice, salt, dust, debris and air pressure, into the connector 68.

In one embodiment, the clamp assembly 118 includes: (a) a supportive outer conductor engager 132 configured to be inserted into part of the outer conductor 106; and (b) a compressive outer conductor engager 134 configured to mate with the supportive outer conductor engager 132. During attachment of the connector 68 to the cable 88, the cable 88 is inserted into the central cavity of the connector 68. Next, a technician uses a hand-operated tool or electrical power tool to axially push the compressor 124 in the forward direction 94 while holding the connector body 112 in place. For the purposes of establishing a frame of reference, the forward direction 94 is toward interface port 55, and the rearward direction 95 is away from the interface port 55.

The compressor 124 has an inner, tapered surface 136 defining a ramp and interlocks with the clamp driver 121. As the compressor 124 moves forward, the clamp driver 121 is urged forward which, in turn, pushes the compressive outer conductor engager 134 toward the supportive outer conductor engager 132. The engagers 132 and 134 sandwich the outer conductor end 120 positioned between the engagers 132 and 134. Also, as the compressor 124 moves forward, the tapered surface or ramp 136 applies an inward, radial force that compresses the engagers 132 and 134, establishing a lock onto the outer conductor end 120. Furthermore, the compressor 124 urges the driver 121 forward which, in turn, pushes the inner conductor engager 80 into the connector insulator 114.

The connector insulator 114 has an inner, tapered surface with a diameter less than the outer diameter of the mouth or grasp 138 of the inner conductor engager 80. When the driver 116 pushes the grasp 138 into the insulator 114, the diameter of the grasp 138 is decreased to apply a radial, inward force on the inner conductor 84 of the cable 88. As a consequence, a bite or lock is produced on the inner conductor 84.

After the cable connector 68 is attached to the cable 88, a technician or user can install the connector 68 onto an interface port, such as the interface port 52 illustrated in FIG. 5. In one example, the user screws the coupler 128 onto the port 52 until the fingers 140 of the signal carrier 62 receive, and make physical contact with, the inner conductor engager 80 and until the ground 60 engages, and makes physical contact with, the outer conductor engager 86. During operation, the non-conductive, connector insulator 114 and the non-conductive driver 116 serve as electrical barriers between the inner conductor engager 80 and the one or more electrical ground paths surrounding the inner conductor engager 80. As a result, the likelihood of an electrical short is mitigated, reduced or eliminated. One electrical ground path extends: (a) from the outer conductor 106 to the clamp assembly 118, (b) from the conductive clamp assembly 118 to the conductive connector body 112, and (c) from the conductive connector body 112 to the conductive ground 60. An additional or alternative electrical grounding path extends: (a) from the outer conductor 106 to the clamp assembly 118, (b) from the conductive clamp assembly 118 to the conductive connector body 112, (c) from the conductive connector body 112 to the conductive coupler 128, and (d) from the conductive coupler 128 to the conductive ground 60.

These one or more grounding paths provide an outlet for electrical current resulting from magnetic radiation in the vicinity of the cable connector 88. For example, electrical equipment operating near the connector 68 can have electrical current resulting in magnetic fields, and the magnetic fields could interfere with the data signals flowing through the inner conductor 84. The grounded outer conductor 106 shields the inner conductor 84 from such potentially interfering magnetic fields. Also, the electrical current flowing through the inner conductor 84 can produce a magnetic field that can interfere with the proper function of electrical equipment near the cable 88. The grounded outer conductor 106 also shields such equipment from such potentially interfering magnetic fields.

The internal components of the connector 68 are compressed and interlocked in fixed positions under relatively high force. These interlocked, fixed positions reduce the likelihood of loose internal parts that can cause undesirable levels of passive intermodulation (“PIM”) which, in turn, can impair the performance of electronic devices operating on the networks 2 and 12. PIM can occur when signals at two or more frequencies mix with each other in a non-linear manner to produce spurious signals. The spurious signals can interfere with, or otherwise disrupt, the proper operation of the electronic devices operating on the networks 2 and 12. Also, PIM can cause interfering RF signals that can disrupt communication between the electronic devices operating on the networks 2 and 12.

In one embodiment where the cables of the networks 2 and 12 include fiber optic cables, such cables include fiber optic cable connectors. The fiber optic cable connectors operatively couple the optic tubes to each other. This enables the distribution of optical or light-based signals between different cables and between different network devices.

1.7 Supplemental Grounding

In one embodiment, grounding devices are mounted to towers such as the tower 36 illustrated in FIG. 4. For example, a grounding kit or grounding device can include a grounding wire and a cable fastener which fastens the grounding wire to the outer conductor 106 of the cable 88. The grounding device can also include: (a) a ground fastener which fastens the ground wire to a grounded part of the tower 36; and (b) a mount which, for example, mounts the grounding device to the tower 23. In operation, the grounding device provides an additional ground path for supplemental grounding of the cables 88.

1.8 Environmental Protection

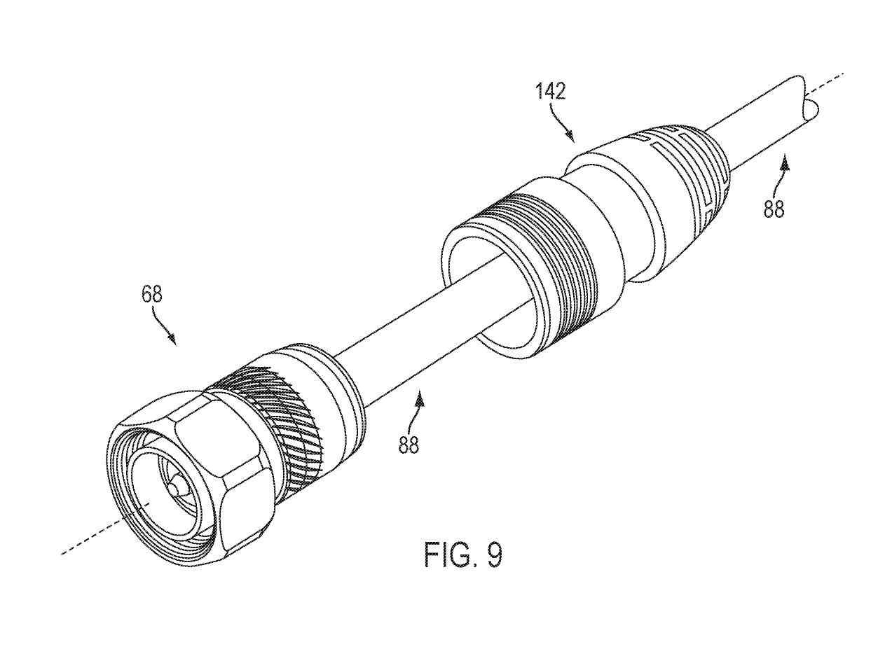

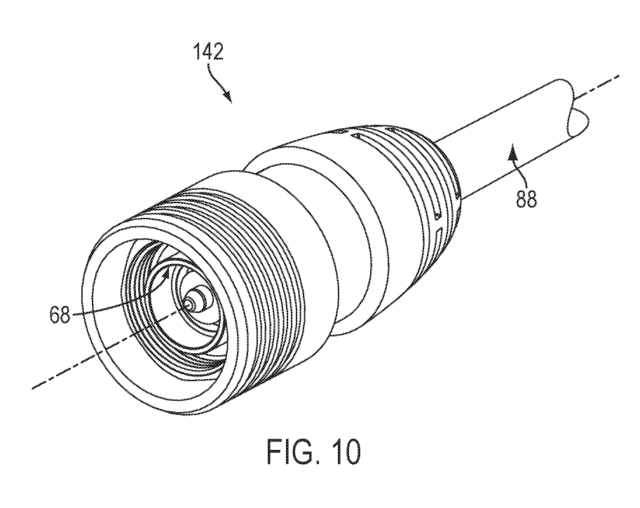

In one embodiment, a protective boot or cover, such as the cover 142 illustrated in FIGS. 9-10, is configured to enclose part or all of the cable connector 88. In another embodiment, the cover 142 extends axially to cover the connector 68, the physical interface between the connector 68 and the interface port 52, and part or all of the interface port 52. The cover 142 provides an environmental seal to prevent the infiltration of environmental elements, such as rain, snow, ice, salt, dust, debris and air pressure, into the connector 68 and the interface port 52. Depending upon the embodiment, the cover 142 may have a suitable foldable, stretchable or flexible construction or characteristic. In one embodiment, the cover 142 may have a plurality of different inner diameters. Each diameter corresponds to a different diameter of the cable 88 or connector 68. As such, the inner surface of cover 142 conforms to, and physically engages, the outer surfaces of the cable 88 and the connector 68 to establish a tight environmental seal. The air-tight seal reduces cavities for the entry or accumulation of air, gas and environmental elements.

1.9 Materials

In one embodiment, the cable 88, connector 68 and interface ports 52, 53 and 55 have conductive components, such as the inner conductor 84, inner conductor engager 80, outer conductor 106, clamp assembly 118, connector body 112, coupler 128, ground 60 and the signal carrier 62. Such components are constructed of a conductive material suitable for electrical conductivity and, in the case of inner conductor 84 and inner conductor engager 80, data signal transmission. Depending upon the embodiment, such components can be constructed of a suitable metal or metal alloy including copper, but not limited to, copper-clad aluminum (“CCA”), copper-clad steel (“CCS”) or silver-coated copper-clad steel (“SCCCS”).

The flexible, compliant and deformable components, such as the jacket 104, environmental seals 122 and 130, and the cover 142 are, in one embodiment, constructed of a suitable, flexible material such as polyvinyl chloride (PVC), synthetic rubber, natural rubber or a silicon-based material. In one embodiment, the jacket 104 and cover 142 have a lead-free formulation including black-colored PVC and a sunlight resistant additive or sunlight resistant chemical structure. In one embodiment, the jacket 104 and cover 142 weatherize the cable 88 and connection interfaces by providing additional weather protective and durability enhancement characteristics. These characteristics enable the weatherized cable 88 to withstand degradation factors caused by outdoor exposure to weather.

2.0 Interference Reduction System

Referring to FIGS. 1, 2 and 11-12, in one embodiment, the interference reduction system 200 is implemented in a building 16, facility, park, stadium 8, venue or other open or closed environment 202. The cellular tower 5 is operable to generate micro cell or pico cell coverage for the environment 202 as described below. There are one or more DAS remote antenna units 24 mounted or installed on top of or inside the environment 202. The DAS manager 22 manages and controls the DAS antenna units 24 as described above.

Depending upon the embodiment, the DAS manager 22 receives signals from the repeater 20, or the DAS manager 22 receives signals directly from the nearby base station 204. In one embodiment, the DAS manager 22 is operatively coupled to the base station 204 through a coaxial cable. In another embodiment, the DAS manager 22 is operatively coupled to a plurality of base stations 204 through a plurality of coaxial cables.

The environment 202 has a plurality of interference sources 206. The interference sources 206 can include any object, located in or near the environment 202, that is positioned to receive electromagnetic radiation from any DAS remote antenna unit 24 and reflect part or all of the radiation back toward a DAS remote antenna unit 24. Depending upon the design or setup of the environment 202, the interference sources 206 can include building fixtures, building hardware, building structures and parts (such as sheet metal heat ducts, metal vents, metal flashing and metal ceiling tile frames), street lamps, electrical power lines, aircraft and other moving and nonmoving items in or near the environment 202.

In addition, the interference sources 206 can include any electromagnetic radiation generator in or near the environment 202, including, but not limited to, micro antennas near the environment 202, macro antennas near the environment 202, electrical wires and equipment in the environment 202, electrical devices in the environment 202 and rooftop or macro antennas of buildings near the environment 202.

It should be appreciated that the interference sources 206 in a building, for example, can change over time. For example, when the building is first built, the metal heat ducts may be installed in one location where they do not cause reflective interference with the DAS antenna units 24. In two years, however, the building might be upgraded, and new heat ducts could be installed in a different location where they cause reflective interference with one or more DAS antenna units 24.

The interference sources 206 can cause interference with the antenna signals of the DAS antenna units 24 in a number of ways. The interferences sources 204 can significantly reduce the power of the antenna signals of DAS antenna units 24, or the interferences sources 206 can cancel all, or substantially all, of an antenna signal of a DAS antenna unit 24. In addition, the interference sources 206 can cause PIM to be present in the DAS antenna units 24, in the signal-carrying cables and in the indoor wireless communication network 12. Consequently, the PIM and interference sources 206 can cause degradation, interruption or loss of cellular service for subscribers in or near the environment 202.

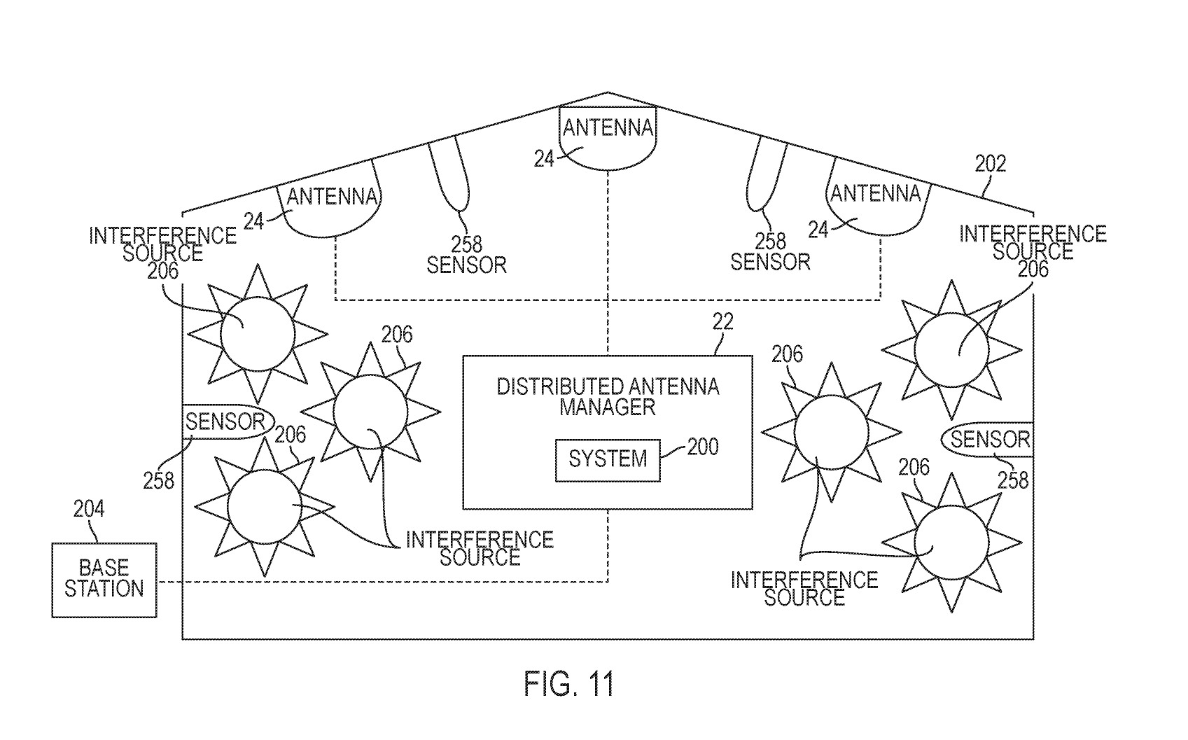

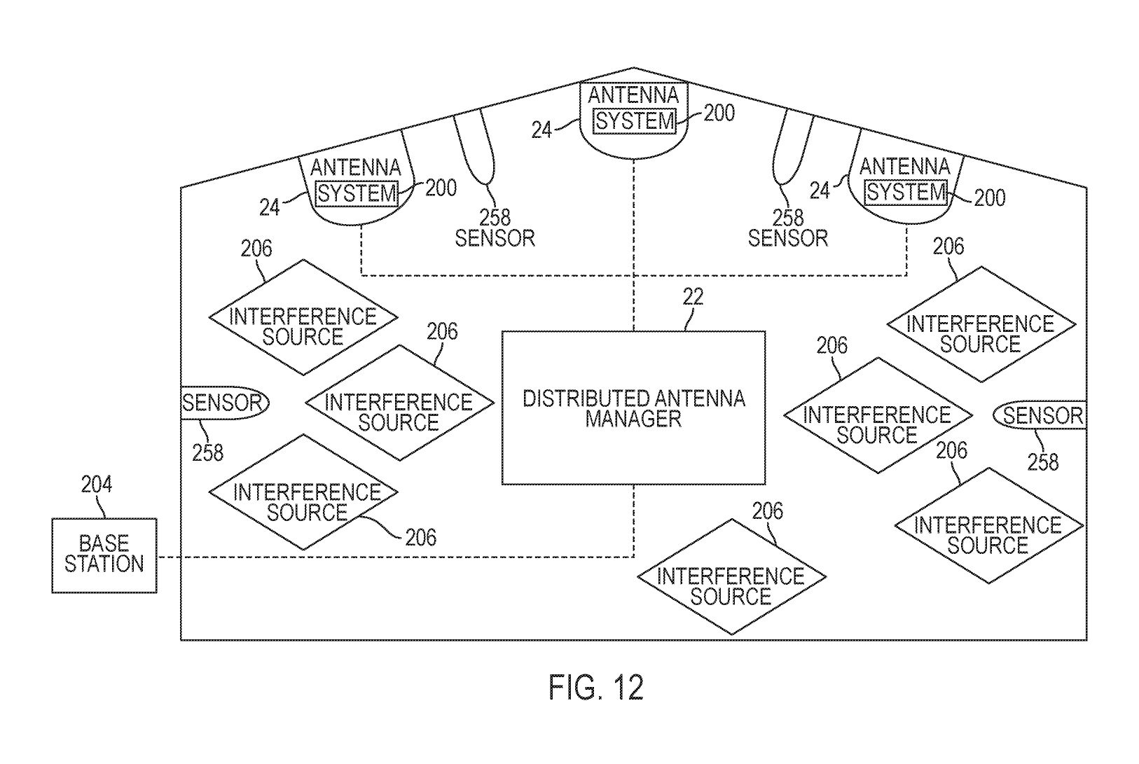

The interference reduction system 200 is operable to reduce the problems cause by such interference. In the embodiment illustrated in FIG. 11, the system 200 is fully or partially incorporated into the DAS manager 22. In the embodiment illustrated in FIG. 12, the system 200 is replicated, and each replica of the system 200 is fully or partially incorporated into one of the DAS remote antenna units 24 or the associated remote radio unit or head 270 described below.

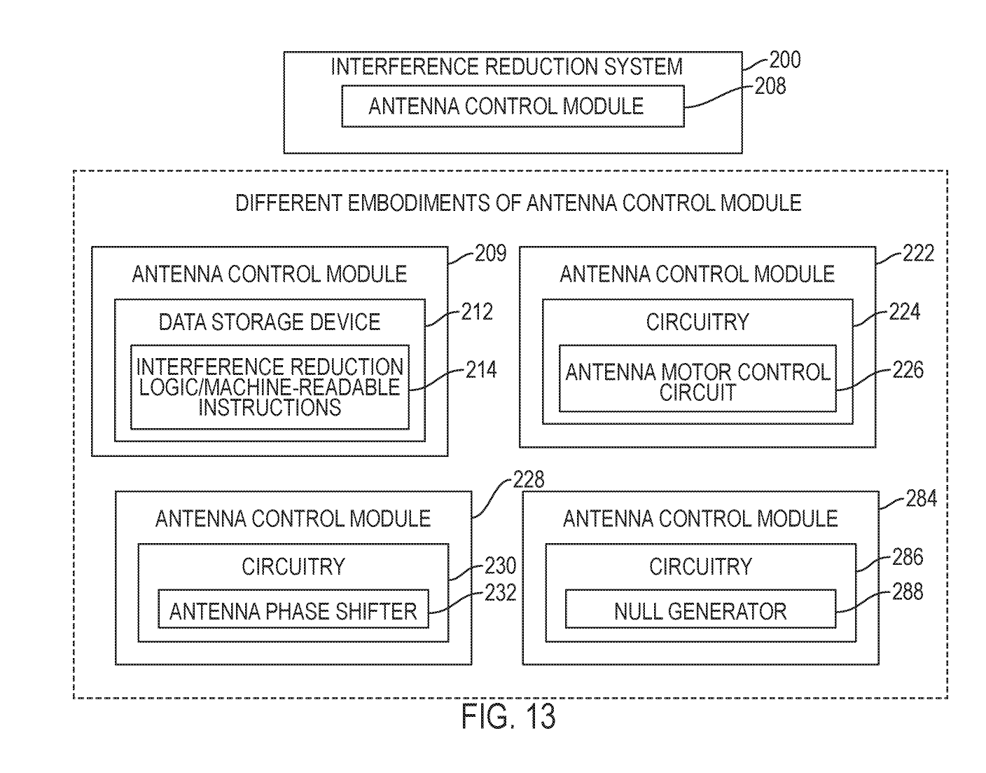

Referring to FIG. 13, the interference reduction system 200, in one embodiment, includes an antenna control module 208. The antenna control module 208 is operable to control certain functionality of one or more of the DAS remote antenna units 24.

In one embodiment, the antenna control module 209 includes a memory device or data storage device 212. The data storage device 212 stores interference reduction logic 214 in the form of computer code, software, algorithms, data libraries or a plurality of machine-readable instructions. The logic 214 is executable by an integrated circuit or data processor of the DAS manager 22. In one embodiment, the data storage device 212 stores uplink spectral monitoring modules. The spectral monitoring modules are configured to enable spectral monitoring of the environment 202 or applicable antenna unit 24 for interference signals. Depending upon the embodiment, the DAS antennas units 24 can be configured to perform such spectral monitoring, as described below, or the sensors 258 can perform such spectral monitoring.

In one embodiment, the memory devices and data storage devices of the antenna control modules 208 and 209 and the DAS manager 22 are tangible, non-transitory computer-readable storage mediums. Such a storage medium may take many forms, including, but not limited to, non-volatile media and volatile media. Non-volatile media include, for example, optical or magnetic disks, flash drives, or any of the storage devices operating within a computer or server. Common forms of non-transitory computer-readable media therefore include, for example: a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, or any other medium from which a computer can read programming code and/or data. Many of these forms of computer readable media may be involved in carrying one or more sequences of one or more instructions to a processor for execution. Volatile media include dynamic memory, such as main memory of such a computer or server.

In contrast to non-transitory mediums, transitory physical transmission media include coaxial cables, copper wire and fiber optics, including the wires that comprise a bus within a computer system, a carrier wave transporting data or instructions, and cables or links transporting such a carrier wave. Carrier-wave transmission media can take the form of electric or electromagnetic signals, or acoustic or light waves such as those generated during radio frequency (RF) and infrared (IR) data communications.

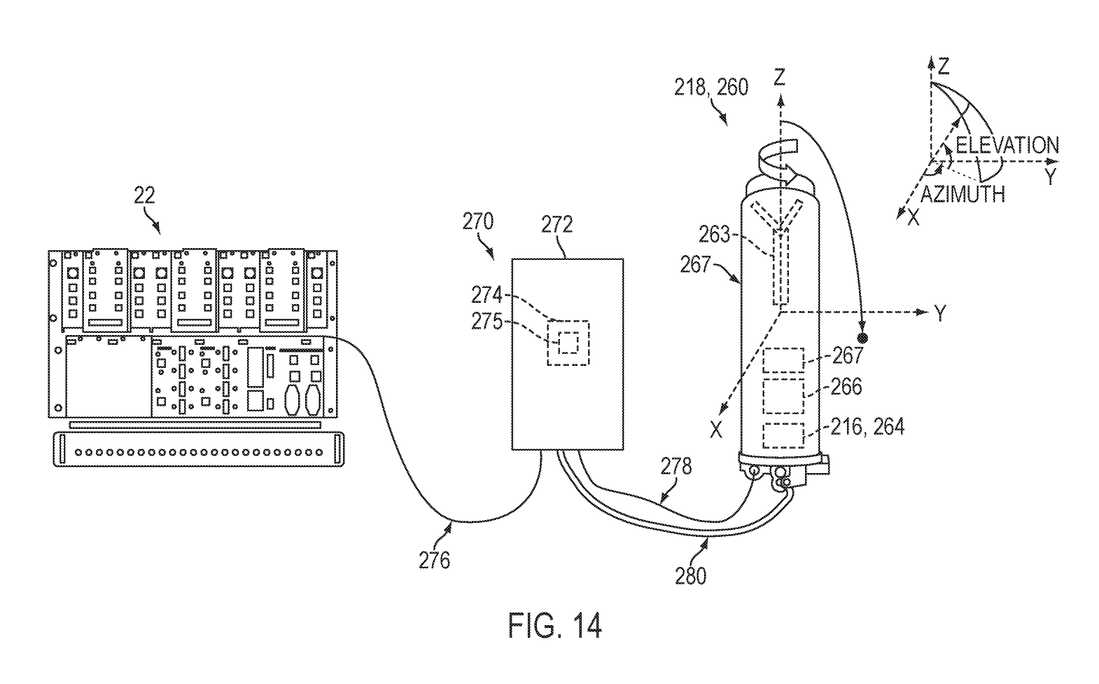

In one embodiment illustrated in FIGS. 13-14, each of the DAS remote antenna units 24 includes an antenna motor 216 as does the DAS remote antenna unit 218. In this embodiment, antenna control module 222 includes one or more interconnected circuits or circuitry 224. The circuitry 224 includes an antenna motor control circuit 226. The antenna motor control circuit 226 is configured to control the operation of the antenna motor 216. As described below, the antenna motor 216 is operable to change the radiation pattern of a DAS antenna unit 218 by physically rotating or repositioning the radiator 263 of the DAS antenna unit 218. The change in the radiation pattern results in a reduction or elimination of interference as described below.

In another embodiment illustrated in FIG. 13, the antenna control module 228 includes one or more interconnected circuits or circuitry 230. The circuitry 230 includes an antenna phase shifter 232. As described above, the antenna phase shifter 232 is operable to change the radiation patterns of the DAS antenna units 24 to tilt the patterns in different directions. The phase shifter 232 can change the phase of the antenna signal by changing the effective length of the radiator's conductive path thereby changing the signal's wavelength. Depending upon the embodiment, the antenna phase shifter 232 can change the phases of the radiation signals with or without the role of a phase control motor. In either case, the antenna phase shifter 232 is operable to change the radiation patterns of the DAS antenna units 24 without physically rotating or repositioning the radiators 263 of the DAS antenna units 24 or DAS antenna unit 218. This change in the radiation pattern results in a reduction or elimination of signal interference as described below.

In another embodiment illustrated in FIG. 13, the antenna control module 284 enables the remote radio unit 270 to change the radiation patterns of the DAS antenna units 24 and 218 without physically rotating or repositioning the radiators 263 of the DAS antenna units 24 or DAS antenna unit 218. In this embodiment, antenna control module 284 includes circuitry 286 which, in turn, includes or incorporates a radiation pattern null generator 288. In one embodiment, the null generator 288 is housed within the remote radio unit or head 270. The null generator 288 is operable to generate one or more nulls in the radiation pattern of a DAS antenna unit 24 or 218. The null generation results in a reduction or elimination of signal interference as described below.

In one embodiment, the interference reduction system 200 dynamically and automatically aligns nulls in the antenna radiation pattern with the directions of the PIM or interference sources 206. This reduces the levels or effects of the interference without impairing the signal quality of the transmission in the environment 202.

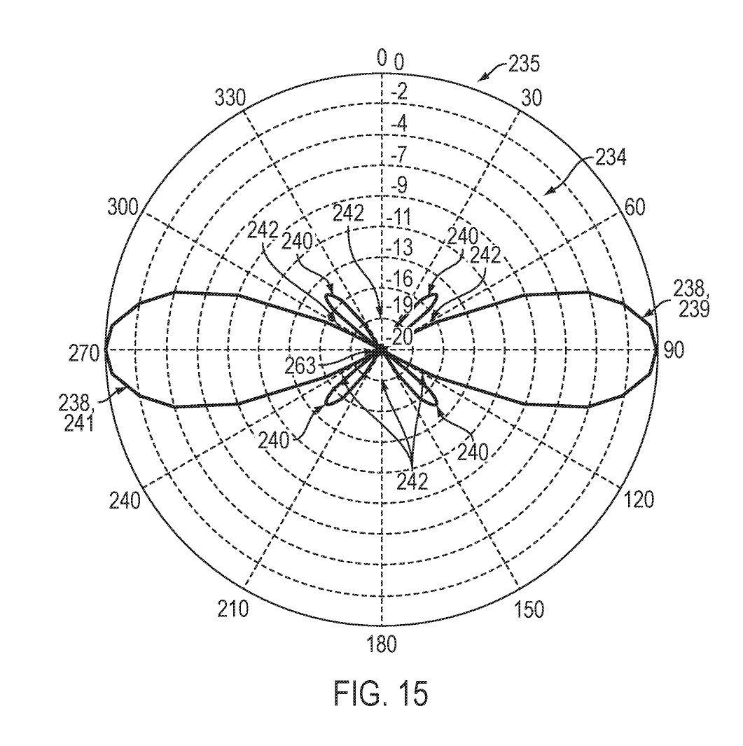

In the example illustrated in FIG. 15, each DAS remote antenna unit 24 is operable to generate electromagnetic waves which cause electromagnetic radiation. In this example, a directional antenna produces radiation that has a horizontal radiation pattern 234 as plotted on the polar plot 235. In the example shown, the dipole or radiator 263 within the directional DAS antenna unit 24 is vertically oriented with its bottom end pointing downward to the earth and its free end pointing upward to the sky. The horizontal radiation pattern 234 is expressed from a top view, looking downward at the free end of the radiator 263. In this example, the radiation pattern 234 has two main beams or main lobes 238, including right beam 239 and left beam 241. The radiation pattern 234 also has four side lobes 240. Furthermore, the radiation pattern 234 has six non-lobe areas or nulls 242 in the spaces between the lobes 238 and 240. The non-lobe areas or nulls 242 are spaces where the signal power is relatively low because the signals of the DAS antenna unit 236 fully, substantially or significantly cancel each other in such spaces.

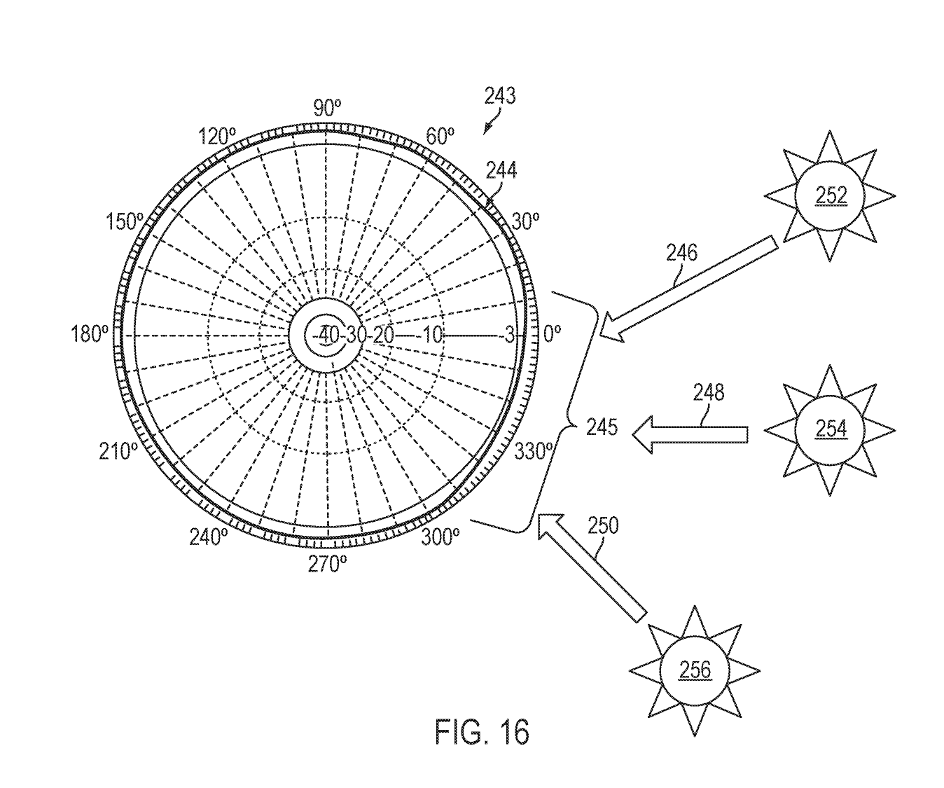

In another example illustrated in FIG. 16, the polar graph 243 for an omni-directional antenna, such as an omni-directional DAS antenna unit 24, illustrates a radiation pattern 244. The radiation pattern 244 includes an asymmetry or relatively small or slight antenna null 245 centered at approximately 330°. In contrast to nulls 242 shown in FIG. 15, in this example the slight null 245 is associated with a relatively small decrease in signal power due to a partial signal cancellation. The slight antenna null 245 is an asymmetry or asymmetrical region of the radiation pattern 244. As shown, the asymmetrical region or slight null 245 has an arc radius that is significantly greater than the radius of the otherwise circular pattern 244. In operation of this example, as described in greater detail below, the system 200 has automatically changed the location of the slight null 245 to align with the directions 246, 248 and 250 of PIM or interference sources 252, 254 and 256, respectively. This eliminates, substantially eliminates or reduces the inference caused by the interference sources 252, 254 and 256.

In one embodiment illustrated in FIGS. 11-13, a plurality of interference probes, detectors or sensors 258 are mounted in the environment 202. The interference sensors 258 are operatively coupled to the DAS manager 22. Depending upon the embodiment, the sensors 258 are coupled to the DAS manager 22 wirelessly or through wires or cables.

In operation, the interference sensors 258 enter into a detection mode when a designated event occurs, such as the satisfaction of a detection start condition. The detection start condition could be the powering-on of the sensors 258, an expiration of a designated period of time or the occurrence of a particular time based on a designated time schedule. In one embodiment, the interference sensors 258 enter the detection mode automatically, independent of, and without reliance upon, any input from a user, technician or human.

During the detection mode, the interference sensor 258 monitors the environment 202 for the presence of interference signals reflected or generated by the interference sources 206. In one embodiment, each interference sensor 258 includes an antenna, a receiver, an antenna holder, a motor and a housing. The motor, coupled to the antenna holder, causes the antenna to automatically rotate to scan the environment 202 for interference signals. The receiver receives the interference signals and produces a sensor signal or detection signal. The sensor's receiver transmits the detection signal to the DAS manager 22 together with data regarding the location, direction and characteristics of the interference signal. The DAS manager 22 controls the DAS antenna units 24 to cause the antenna units 24 to change their radiation patterns so that the nulls are aligned with the lines of direction of such interference signals. In one embodiment, the interference sensors 258 operate autonomously or semi-autonomously during a detection mode. During the detection mode, the interference sensors 258 continuously, incrementally or spectrally monitor the environment 202 for interference signals caused by changes in the environment 202.

In one embodiment, the method of operation is as follows:
(a) The interference sensors 258 are powered-on and activated.
(b) Each interference sensor 258 continuously or incrementally rotates or oscillates to spectrally monitor the environment 202 for interference signals.
(c) When an interference sensor 258 detects an undesirable signal or interference signal, the interference sensor 258 produces one or more detection signals.
(d) The DAS manager 22 receives such detection signal and applies its logic to determine which of the DAS antenna units 24 have been affected by such interference signal.
(e) The DAS manager 22 sends pattern adjustment signals to the remote radio units 270 that are associated with such DAS antenna units 24.
(f) Based on the pattern adjustment signals, such remote radio units 270 control their associated antenna motors 216 to cause the associated antennas 263 to rotate to radial positions where nulls are aligned with the direction of the detected interference signal.
(g) Steps (b) through (f) are continuously and automatically repeated in loop fashion until the interference sensors 258 are disabled for maintenance or service.

In one embodiment, the environment 202 does not include the interference sensors 258. In this embodiment, each DAS antenna unit 24 is an omni-directional antenna unit 260 as illustrated in FIG. 14. The omni-directional antenna unit 260 has: (a) antenna 263, such as a suitable conductor, conductor array, radiator, radiator set, dipole or dipole array; (b) an antenna repositioner 264; (c) a repositioning or drive mechanism 266 which couples the repositioner 264 to the antenna 263; and (d) a housing 267 which covers or encloses part or all of these components and which includes a mount for attachment to a ceiling, wall or support structure.

In one embodiment, the omni-directionality of the DAS antenna unit 260 has a relatively uniform radiation/receiving pattern in most or all directions in at least one plane. In one embodiment, the omni-directional antenna unit 260 has a 360 degree beam width, such as the radiation pattern 243 shown in FIG. 16. The antenna radiation/receiving pattern 243 of the omni-directional antenna unit 260 may include one or more nulls where the antenna pattern 243 is reduced, flattened or the cause of significant asymmetry.

Referring again to FIG. 14, in one embodiment, the repositioner 264 is a rotator which includes the repositioning motor or antenna motor 216. In such embodiment, the drive mechanism 266 includes a drive shaft and one or more drive parts or linkages, such as a gear or set of gears. The omni-directional antenna unit 260 has an antenna holder 267 having one or more guides or bearings configured to enable the rotation or spinning of the DAS antenna unit 260 about the Z-axis. In such embodiment, the radiator or conductor of the DAS antenna unit 260 is configured to extend along its longitudinal axis which, in this example is the Z-axis. The repositioner 264 is operable to rotate the antenna 263 about the Z-axis to change the azimuth angle of the antenna 263.

In one embodiment, the repositioner 264 includes a solenoid, electromagnet, electrical actuator, remote electric tilt (RET) motor, stepper motor or other suitable motor that causes the antenna 263 to: (a) fully or partially rotate about the Z-axis to change its azimuth angle; (b) vertically tilt toward the X-Y plane to change its elevation angle; or (c) both rotate and vertically tilt.

In one embodiment illustrated in FIG. 14, the DAS antenna unit 260 includes, or is operatively connected to, a remote radio head or remote radio unit 270 that controls functions of the DAS antenna unit 260. The remote radio unit 270 has: (a) a housing 272 including a mount for attachment to a wall or support structure; and (b) a controller 274 that is operatively coupled to the DAS antenna unit 260. The controller 274 has a transceiver 275. The transceiver 275 is operable to transmit signals that are radiated by the DAS antenna unit 260, and the transceiver 275 is also operable to receive signals that are directed toward, and received by, the DAS antenna unit 260.

In one embodiment, the antenna controller 274 of the remote radio unit 270 has a memory device, data storage device or circuitry configured to incorporate part or all of the antenna control module 209, 222, 228 or 284 of the system 200. In another embodiment, the DAS antenna unit 260 incorporates part or all of the components and elements of the remote radio unit 270.

In the embodiment illustrated in FIG. 14, the DAS manager 22 is connected to the remote radio head or unit 270 using a fiber optic cable 276. Depending upon the type of environment 202, the remote radio unit 270 can be mounted relatively far away from the DAS manager 22. The remote radio unit 270 transmits data to the DAS antenna unit 260 through the coaxial RF cable 278. Also, the remote radio unit 270 transmits repositioning signals or motor control signals to the antenna motor 216 through a motor control cable 280. Based on such control signals, the antenna motor 216 repositions, oscillates or rotates the antenna 263 within the housing 267. In one embodiment, the motor 216 is controlled using an Antenna Interface Standards Group (AISG) port which is incorporated into the remote radio unit 270.

In operation, the DAS antenna unit 260, under control of the remote radio unit 270, enters into a detection mode when a designated event occurs, such as the satisfaction of a detection start condition. The detection start condition could be the powering-on of the DAS antenna unit 260, an expiration of a period of time, or the occurrence of a particular time based on a designated time schedule. For example, a designated schedule could require the starting of the detection mode on a daily basis after business hours to avoid interruption of cellular service to users in the environment 202.

In one embodiment, the DAS antenna unit 260, under control of the remote radio unit 270, enters the detection mode automatically, independent of any input from a user, technician or human. During the detection mode, the repositioner 264 causes the antenna 260 to automatically reposition or rotate to scan for interference signals in the environment 202. The DAS antenna unit 260, under control of the remote radio unit 270, monitors the environment 202 for interference signals reflected or generated by interference sources 206. The DAS antenna unit 260 continuously, incrementally or spectrally monitors the environment 202 for interference signals caused by changes in the environment 202. In one embodiment, the DAS antenna unit 260 operates autonomously or semi-autonomously during the detection mode.

The DAS antenna unit 260, under control of the remote radio unit 270, receives the interference signals and produces one or more detection signals. The DAS antenna unit 260 transmits the detection signal to the remote radio unit 270 or DAS manager 22 together with data regarding the location, direction and characteristics of the interference signal. The remote radio unit 270 or DAS manager 22 rotates the antenna 260 until its nulls are aligned with the directions of such interference signals.

In one embodiment, an example of the method of operation is as follows:
(a) A detection start condition is satisfied.
(b) The DAS antenna unit 260 enters into a detection mode.
(c) The DAS antenna unit 260 continuously or incrementally rotates or oscillates to spectrally monitor for interference signals in the environment 202.
(d) When the DAS antenna unit 260 detects an undesirable signal or interference signal, the remote radio unit 270 or DAS manager 22 controls the antenna's motor 216 to cause the DAS antenna unit 260 to stop rotating at a radial position where a null is aligned with the direction of the detected interference signal.
(e) The DAS antenna unit 260 exits the detection mode.
(f) Steps (a) through (e) are automatically repeated based on a designated time schedule or the occurrence of designated events.

In one embodiment, the detection mode activity is partially or fully performed during the operation of the antennas, that is, while the DAS antennas are servicing cellular mobile phones in the environment 202.

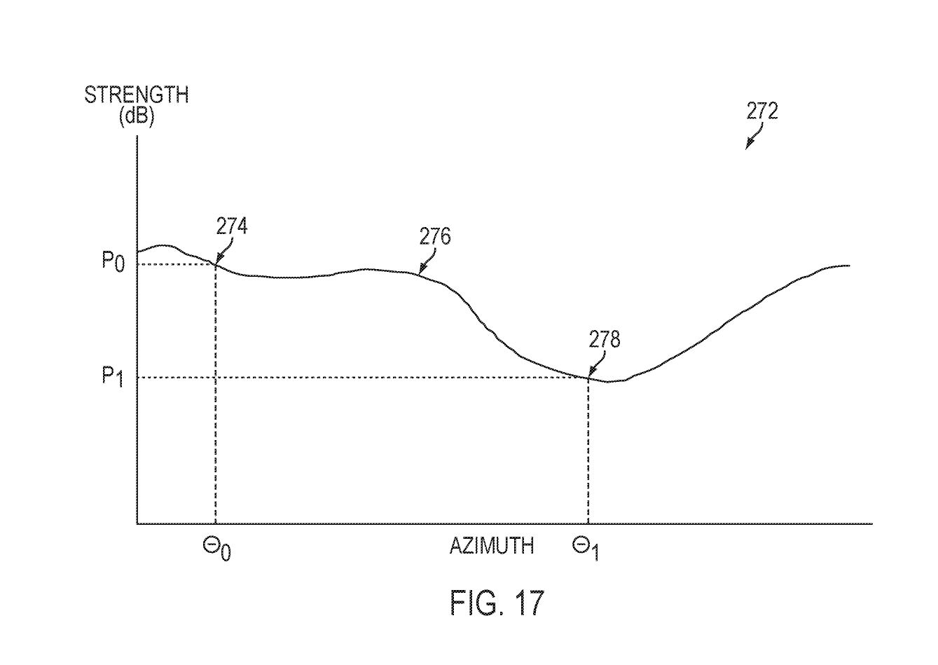

Referring to FIGS. 14 and 17, the curve 272 is an example that represents an estimation of the strength of an interference signal as a function of azimuthal orientation or azimuth angle. In this example, the interference signal is detected at an initial detection point 274, such as by using spectral monitoring to periodically or incrementally check the DAS antenna unit 260. After detecting the interference signal, the antenna motor 216 rotates the antenna 263. The spectrum monitoring module of remote radio unit 270 or DAS manager 22 performs additional spectrum analysis.

The motor 216 then rotates the antenna 263 over a range of antenna orientation angles, and the spectrum monitoring module of remote radio unit 270 or DAS manager 22 performs spectrum analysis at each step. The spectrum analysis is then used to select an orientation associated with point 276 where the strength of the interference signal is sufficiently reduced, for example, at a minimum level. The DAS manager 22 then proceeds to operate the DAS antenna unit 260 at the selected orientation 278.

In another embodiment, the rotation of the antenna 263 may be stopped when the spectrum analysis indicates that the strength of the interference signal is below a designated value or threshold value. This process may be applied where there are multiple interference sources 206. For example, the selection of orientation 278 may be based on an average strength of the interference signals or a weighted analysis of the strengths of the interference signals.

In another embodiment of any one of the embodiments described above, the rotation of the antenna 263 may be based on an algorithm or a set of algorithms. The rotation may be performed in stages, for example, using a large increment for a large range of angles in one stage and then using smaller increments in a smaller sub-range of angles in another stage. Additionally, the increment may be based on the size of a null.

Referring back to FIG. 13, it should understood that the antenna control modules 228 and 284 are operable to reduce interference for a DAS antenna unit 24 even when such unit 24 does not have a motor or antenna repositioner. For example, the antenna control module 228 enables the remote radio unit or head 270 to achieve null alignment with the interference signals without physically rotating or repositioning the antenna of the DAS antenna unit 24. In one embodiment, the antenna phase shifter 232 is housed within the remote radio unit 270. The phase shifter 232 is operable to shift the phases of the signal waves produced by a plurality of radiator elements in the antenna unit 24. This phase shifting for the antenna unit 24 causes its radiation pattern to change so as to align the its nulls with the directions of the interference signals. With respect to antenna control module 284, the null generator 288 is operable to produce nulls in the radiation pattern of an antenna unit 24. The nulls are produced at selected radial locations that align with the directions of the interference signals.

In one embodiment, the DAS manager 22 communicates with, and receives an RF feed from, the base station 204. In another embodiment, the base station 204 transmits key performance indicators (“KPI”) data to the DAS manager 22. The KPI data relates to characteristics of the cellular traffic, network performance and antenna signals, such as information related to the volume of dropped calls. The DAS manager 22 receives the KPI data feed from the base station 204 through a common public radio interface (“CPRI”). In this embodiment, the DAS manager 22 performs the null alignment steps described above based, at least in part, on this KPI data. Depending upon the embodiment: (a) the DAS manager 22 could cause the DAS antenna units 24 to rotate based on the KIP data, (b) the DAS manager 22 could cause the DAS antenna units 24 to generate nulls based on the KIP data, or (c) the DAS manager 22 could cause the DAS antenna units 24 to reposition nulls based on the KIP data.

By repositioning a DAS antenna or otherwise altering the radiation pattern, the system 200 reduces or minimizes interference encountered by the DAS antenna. This enables the system to dynamically orient nulls in the antenna pattern based on interference power level detected. The null alignment, null steering, null manipulation or null production process of the system 200 provides significant performance gains in the antenna network resulting from the decrease in interference. In this way, the system 200 performs an automated, dynamic reduction or minimization of the effects of the antenna interference.

3.0 Remote Control of DAS Antennas

In one embodiment, a remote control device enables a technician to control the movement of the antenna of a DAS antenna unit 218 mounted in an environment 202, such as a building. In such embodiment, the DAS manager 22 or remote radio unit or head 270 includes a remote control module. The remote control logic of such module enables the remote control device to communicate with the DAS manager 22 or radio unit 270. In one embodiment, the remote control device is a handheld remote control operable to send and receive RF, infrared or other signals wirelessly. In another embodiment, the remote control device is a cell phone, computer notebook, computer laptop or Internet access device. Using the remote control device, a technician can control the movement of the antenna or radiator within the DAS antenna unit 218 to eliminate or reduce interference from interference sources 206. For example, instead of having to climb a ladder to reach a DAS antenna unit 218, the technician can remain on the floor and enter position adjustments inputs by pressing buttons or typing on a keyboard of a computer or other remote control device. The technician's inputs adjust the orientation of the antenna or radiator within the DAS antenna unit 218 even though it may be fifty feet or more above floor level. After adjustment, the technician checks the antenna unit's interference and performance. Based on that check, the technician can make further adjustment inputs until achieving the desired performance. In this embodiment, the technician may perform the null alignment procedures described above or any other suitable adjustment techniques.

4.0 Antenna Beam Manipulator

In one embodiment, an antenna beam manipulator is operable to steer, produce or form one or more beams of a directional antenna of a DAS antenna unit 24. The antenna beam manipulator, in one embodiment, includes logic storable by the data storage device 212 of the DAS manager 22 in the form of computer code, software, beam steering algorithms, beam forming algorithms, data libraries, a plurality of machine-readable instructions or a combination thereof. Such logic is executable by an integrated circuit or data processor of the DAS manager 22. In another embodiment, the antenna beam manipulator has a hardware form, including beam steering circuitry or beam forming circuitry. In such embodiment, the hardware can include one or more electrical switches, dielectric components, resisters, capacitors, inductors and transformers.

Referring to FIGS. 14-15, the antenna beam manipulator enables the DAS manager 22 to automatically steer the beams 238 of a directional antenna unit 218 toward desired targets or otherwise form beams 238 so that they are directed toward desired targets. The targets can be located in or near the environment 202 which may be, for example, a stadium, an outdoor concert or an outdoor amusement park.

In one embodiment, a plurality of motion detectors, infrared heat sensors, sensors, video recorders, satellites or other crowd monitors could be mounted or operated to detect relatively high concentrations of attendees, including people using cellular phones. The crowd monitors are operatively coupled to the DAS manager 22. The crowd monitors continuously or periodically send crowd detection signals to the DAS manager 22. Each crowd detection signal is associated with: (a) a designated level of crowd concentration or density; and (b) geographical data or directional data related to the location of the crowd, such as spatial coordinates. Based on a crowd detection signal, the DAS manager 22 automatically steers one or more beams 238 of a directional antenna unit 218 toward the location of the crowd or otherwise forms one or more beams 238 so that they are directed toward the crowd. As a result, the beams 238 can reach the targeted crowd with higher strength and enhanced performance.

Accordingly, the antenna beam manipulator, in cooperation with the target monitors, enables the DAS manager 22 to automatically and dynamically adjust the orientation and performance of the antenna units 218, in feedback loop fashion, based on changes in designated targets in or near the environment 202.

With continued reference to FIGS. 14-15, in one embodiment, the environment 202 receives RF feeds through coaxial cables from a plurality of base stations 204, such as base station A and base station B. The DAS manager 22, under control of the antenna beam manipulator, is operable to produce or steer antenna beams 238 so that beam 239 is aimed at crowd population A, and beam 141 is aimed at crowd population B. The DAS manager 22 uses base station A's RF feed to operate beam 239, and the DAS manager 22 uses base station B's RF feed to operate beam 241. In this way, each crowd population can receive a relatively high level of signal power from a non-shared base station.

In another embodiment, the DAS manager 22 is operable according to the antenna beam manipulator without reliance upon target sensors or monitors. The following is an example method of operation of such embodiment:
(a) The DAS manager 22 activates and powers-on a plurality of directional antenna units 218.
(b) Under control of the DAS manager 22, each directional antenna unit 218 enters into search mode when a designated search mode start condition is satisfied.
(c) During search mode, each directional antenna unit 218 continuously rotates three hundred sixty degrees or oscillates back and forth between an angle less than three hundred sixty degrees.
(d) During the rotation or oscillation, the directional antenna unit 218 transmits search result signals to the DAS manager 22.
(e) The DAS manager 22 applies its logic to determine when the search result signals correspond to, and indicate, the locations of targets, such as dense crowd populations.
(f) The DAS manager 22 controls each directional antenna unit 218 to stop its rotation or oscillation at a position so that its beam 238 is aimed toward one of the targets.
(g) Under control of the DAS manager 22, each directional antenna unit 218 ends the search mode and then sends and receives signals for cellular service.
(h) When the search mode start condition occurs again, steps (b) through (g) are automatically repeated as part of a feedback loop.

In one embodiment, the beam manipulator incorporates a beam steering module or beam steerer. The beam steerer is operable to change the aim of a beam by electrically switching the antenna radiators or by changing the relative phases of the RF signals that drive the antenna radiators. In another embodiment, the beam manipulator incorporates a beam former. The beam former is operable to change the directionality of an array of radiators by controlling the phase and relative amplitude of the radiated signal of each radiator. The resulting radiation pattern is based on constructive and destructive interference in the wavefront. The signals received from the different radiators can be amplified by different “weights.” Different weighting patterns can be used to achieve desired sensitivity patterns. Depending upon the embodiment, the beam former can be a fixed or switched-type beam former, a phased array beam former or an adaptive beam former.

In one embodiment, the antenna beam manipulator is operable without reliance upon the interference reduction system 200 and without the involvement of null detection. In another embodiment, the antenna beam manipulator is fully or partially incorporated into the interference reduction system 200.

5.0 ElectroMagnetic Energy (EME) Interrupter

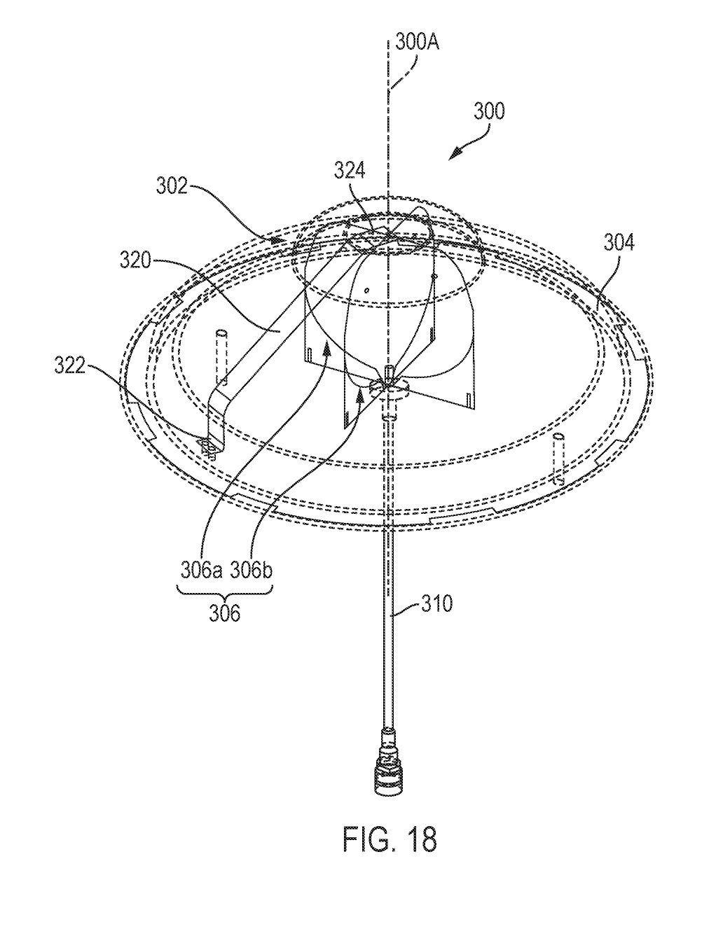

In FIG. 18, a telecommunications antenna 300 is mounted within a ceiling structure of a conventional office or commercial building. The telecommunications antenna 300 includes an outer housing or radome structure 302 which is transparent to electromagnetic energy for exchanging broadband signals to and from cellular customers/devices. The radome 302 is limited in size to about eight inches (8″) in diameter and about six inches (6″) in height. As mentioned in the background of the invention, building residents and service providers often mandate or stipulate that the size of such antennas be limited to maintain the overall building aesthetics while mitigating concerns regarding occupant exposure to harmful levels of radiation.

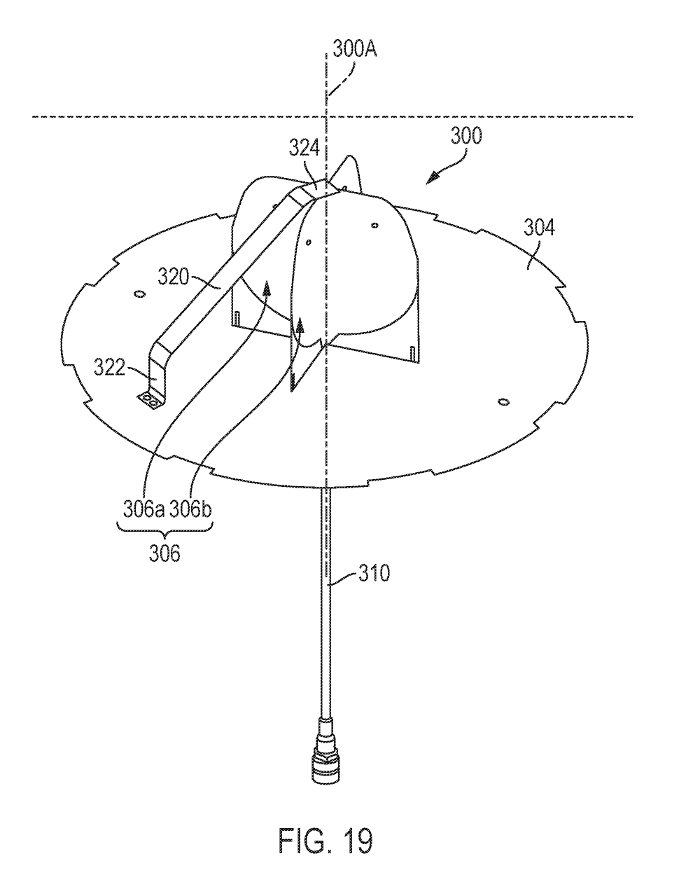

In FIGS. 18 and 19, the telecommunications antenna 300 includes a generally planar, conductive base or ground plane 304 having mounted thereto a pair of dipole assemblies or broadband radiators 306, 308 (FIG. 19) each comprising a first dipole, leg or radiating element 306a, 308a and a second dipole, leg, or radiating element 306b, 308b (hereinafter referred to as “dipole elements”). The first and second dipole elements 306a, 306b, 308a, 308b project outwardly from the conductive ground plane 304, and, in the illustrated embodiment, project orthogonally, or at right angles relative to, the ground plane 304. Jumper cables 310a, 310b exchange broadband signals between ports (not shown) along the underside of the telecommunications antenna 300 and a Distributed Antenna System (DAS).

In the broadest sense of the invention, the broadband radiators 306, 308 produce a beam pattern indicative of the performance of the radiator's signal transmission/reception. As previously discussed, a radiator's performance can be affected by a variety of factors including the density of subscribers/users, the antenna throughput capacity/gain, sources of interference, background noise, the signal Strength to INterference Ratio (SINR), and QUALCOM (i.e., the difference between the Signal Strength and the Interference/Noise). Furthermore, all of the foregoing can be dynamic, i.e., can change, due to relatively minor changes to surrounding structures having the capacity to reflect, resonate and amplify signals impacting the radiator's beam pattern/performance. In the described embodiment, the telecommunications antenna 300 includes an ElectroMagnetic Energy (EME) interrupter 320 which electrically connects to the conductive ground plane 304 and inhibits the transmission/reception of electromagnetic energy within a sector of the beam pattern.

The EME interrupter 320 comprises an electrically conductive strip such as aluminum, copper, brass or steel which mounts to the conductive ground plane 304 at one end 320_{E1}, and extends to an axis of symmetry 300A at the other end 300_{E2} which is normal to, and projects orthogonally from, the conductive ground plane 304. In the described embodiment, the interrupter 320 may be slidably mounted within one or more arcuate slots 324 formed in the conductive ground plane 304. Alternatively, the interrupter 320 may be mounted to a ring (not shown) slideably mounted to a circular edge of the conductive ground plane 304. The ring may be driven about the axis 300A by a wheel which frictionally engages a surface of the ring to position the EME interrupter 320 at any angular position around the ground plane 304.

In the described embodiment, the EME interrupter 320 defines a width dimension (W) which corresponds to a sector angle α (see FIG. 18) between about one degree (1°) to about twenty (20°) degrees. Alternatively, the width dimension (W) of the EME interrupter 320 corresponds to a sector angle α between about two degrees (2°) to about ten (10°) degrees. While the EME interrupter 320 may include a single arcuate, inclined or sloping conductive strip 320, the interrupter 320 may include a plurality of strips (not shown) which may be juxtaposed or adjacent to each other, i.e., disposed edge-to-edge, such that the strips are cumulative, additive or overlapping thereby increasing or decreasing the effectiveness of the inhibitor 320.

The first dipole elements 306a, 308a are configured to be tuned to a first frequency while the second dipole elements 306b, 308b thereof are configured to be tuned to a second frequency. In the described embodiment, the second dipole elements 306b, 308b are configured to be tuned to a second frequency higher than the first frequency. As a consequence of this teaching, the first dipole elements 306a, 306b will necessarily be longer, i.e., in spanwise length dimension, than the length dimension of the second dipole element 304b. That is, since tuning is a function of the quarter-wavelength (¼)(λ) of the target frequency (ν), the lower frequency/longer wavelength of the first dipole elements 306a, 308a will necessarily be longer than the higher frequency/shorter wavelength of the second dipole elements 306b, 308b.

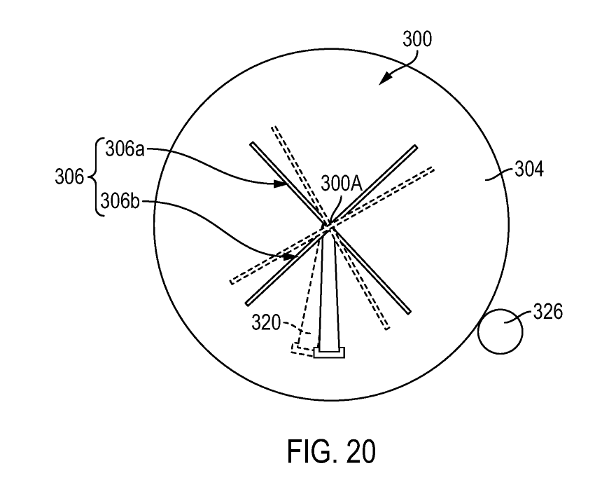

In FIGS. 19 and 20, the dipole elements 306a, 306b, 308a, 308b are generally metallic and are electrically grounded to the conductive ground plane 304 to produce a short circuit. DC current fed into the λ/4 dipole elements 306a, 306b, 308a, 308b transforms the short circuit into an open circuit which has no effect on the signals on the line. In the described embodiment, the dipole elements 306a, 306b, 308a, 308b comprise one or more laminates of a fiber-reinforced resin matrix material having a metallic layer bonded to, or interposing the layers of, the composite laminate. The first dipole elements 306a, 308a, which are longer than the second dipole elements 306b, 308b, may be formed by a metallic trace 312a, 314a (shown in phantom lines) extending along the outer periphery of the first dipole elements 306a, 306b. The metallic trace 312a, 314a projects downwardly at the outboard end 315a of each of the elements 306a, 308a for soldering to a conductive brass fitting 316 in the conductive ground plane 304.

In addition to projecting orthogonally from the conductive ground plane 304, the first and second dipole elements 306a, 306b, 308a, 308b intersect along vertical lines 320, 322 oriented normal to the plane of the ground plane 304. The dipole elements 306a, 306b, 308a, 308b of each broadband radiator 306, 308, i.e., the first and second dipole elements 306a, 306b of the first broadband radiator 306 and the first and second dipole elements 308a, 308b of the second broadband radiator 308 cross in a mid-span region to form a generally cruciform shape.

In FIGS. 19 and 20, the telecommunications antenna 300 includes first and second dipole elements 306a, 306b, 308a, 308b which are selectively tuned such that the first dipole elements 306a, 308a are longer than the respective second dipole elements 306b, 308b. In one embodiment, the first dipole elements 306a, 308a, correspond in size, i.e., in length, to about ¼ (λ), wherein the wavelength (λ) corresponds to a frequency (ν) which is less than about one-thousand seven hundred megahertz (1700 MHz). The second dipole elements 306b, 308b correspond in size, i.e., in length, to about ¾ (λ), wherein the wavelength (λ) corresponds to a frequency (ν) which is greater than or equal to about one-thousand seven hundred megahertz (1700 mHz).

In another embodiment, the first dipole elements 306a, 308a, have a length corresponding in size to a frequency (ν) which is less than about one-thousand megahertz (1000 MHz). In the same embodiment, the second dipole elements 306b, 308b have a length corresponding in size to a frequency (ν) which is greater than or equal to about one-thousand seven hundred megahertz (1700 MHz).

In yet another embodiment, the first dipole elements 306a, 308a, correspond in size) i.e., ¼ (λ), to a frequency (ν) of about eight-hundred twenty-five mega-hertz (825 MHz), which is the average frequency in the low broadband range. This range extends from about six hundred and ninety mega-hertz (690 MHz) to about nine hundred and sixty mega-hertz (960 MHz). The second dipole elements 306b, 308b correspond in size, i.e., ¼ (λ), to a frequency (ν) of about two-thousand, two-hundred and ninety-five mega-hertz (2295 MHz), which is the average frequency in the high broadband range. This range extends from about one-thousand six-hundred and ninety-five mega-hertz (1695 MHz) to about two-thousand six-hundred and ninety mega-hertz (2690 MHz).

In the described embodiment, isolation standoffs 340, 350a, 350b are interposed between the first and second dipole elements 306a, 306b, 308a, 308b of the dipole assemblies 306, 308. A low-band standoff 340 is disposed midway between the first dipole elements 306a, 308a. Further, a pair of high-band standoffs 350a, 350b are disposed between each outwardly facing leg of the first dipole elements 306a, 308a and each inwardly facing leg of the second dipole elements 306b. 308b. The isolation standoffs 340, 350a, 350b have the effect of re-directing electrical current such that isolation is maximized between the broadband radiators 306, 308.

Operationally, a distributed antenna system of the types previously described are located within an area targeted for transmission and receipt of RF signals, i.e., to and from telecommunication subscribers. For example, a distributed antenna system for a sports stadium would include several hundred antennas of the type described above in areas where subscribers/users will be using their mobile devices. Such areas include the seats surrounding the playing field and along the interior corridors which circumscribe the facility, typically on several levels or floors. The objective is to provide coverage, i.e., a beam pattern, without significant overlap from one antenna to another.

The telecommunication antennas of the present disclosure will be positioned to minimize interference while maximizing throughput or the number of users which are covered by each beam pattern of the installed antennas. The objective is to employ as few antennas as possible to minimize cost while enhancing the aesthetics of the facility. When employing a telecommunication antenna 300 of the type described herein, an installer will identify areas of interference and point the EME interrupter 320 in the direction of the interference. As discussed earlier, this can be performed manually or automatically by sensors capable of locating points of interference within a zone/area of coverage. Generally, this operation will initially be performed manually with the aid of a variety of test equipment to locate sources of interference. Subsequently, the operation is performed automatically by dynamically-controlled antennas which are rotated into a position based upon sensed SIgnal to Noise/interference Ratio (SINR) inputs. That is, antennas will be periodically rotated to find the maximum source of interference. This can be performed by an algorithm which iteratively measures the SINR input.

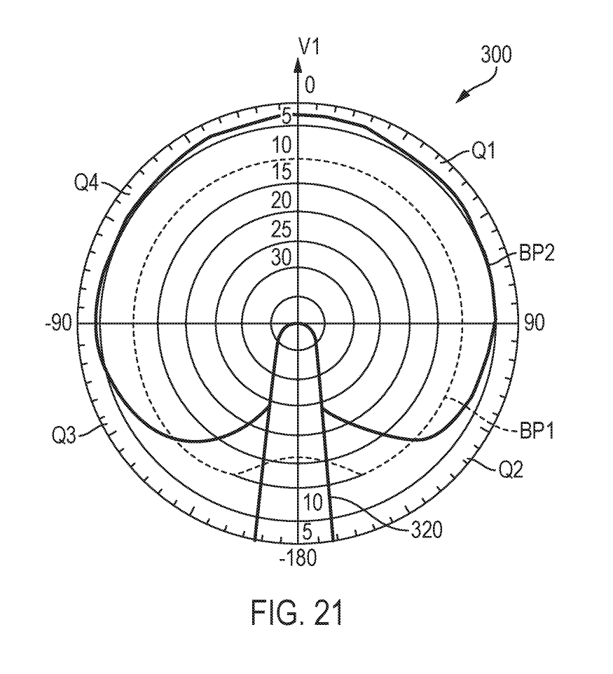

FIG. 21 shows a hypothetical scenario of a beam pattern both with and without the EME interrupter 320 and the influence/affect the EME interrupter 320 has on the antenna beam pattern. The beam pattern BP1 shown as a dashed line depicts a typical pattern produced by the radiators 306, 308 of the antenna 300. An examination thereof shows maximum coverage in the first and fourth quadrants, i.e., at about zero degrees (0°), which requires a transmission of 8 Dbi to send/receive the signals of telecommunication subscribers. Furthermore, an area of interference, i.e., at about one hundred and eighty degrees (180°), is shown in the second and third quadrants, diametrically opposed to the high gain produced in the first and fourth quadrants. With this information, an installer mounts the EME interrupter 320 in alignment with the source of the interference thereby shifting the beam pattern BP2 to maximize the gain/throughput in the first and fourth quadrants. Such increased coverage is depicted by the increase in area enveloped by the curve or beam pattern BP2. As a consequence, the EME interrupter 320 blocks or inhibits the transmission of energy in an area of interference, such as may be produced by any resonating structure excited by the energy emitted by the telecommunications antenna.

While the antenna of the present disclosure has been described in the context of a Distributed Antenna System (DAS), it will be appreciated that the antenna may be employed in any telecommunication system such as an omnidirectional or sector antenna of a macro telecommunication system. While the EME interrupter 320 is shown as a strip of conductive material, it may be plurality of conductive wires or a braided wire disposed across a beam producing radiator. While the inventive antenna is described in the context of a Multiple Input Multiple Output (MIMO) antenna system, it should be appreciated that the teaching are equally applicable to any antenna system such as a Single Input Single Output (SISO), or a Single Input Multiple Output (SIMO) antenna.

Additional embodiments include any one of the embodiments described above, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

The following is claimed:

1. An electromagnetic antenna, comprising:
a conductive ground plane;
a radiator spatially positioned relative to the conductive ground plane and producing a beam pattern indicative of the performance of the radiator's signal transmission/reception; and
an ElectroMagnetic Energy (EME) interrupter electrically connected to the conductive ground plane and operative to electrically inhibit the transmission/reception of electromagnetic energy within a sector of the beam pattern.

2. The electromagnetic antenna of claim 1, wherein the sector of the beam pattern inhibited by the interrupter corresponds to a sector angle of between about one degree (1°) to about twenty degrees (20°).

3. The electromagnetic antenna of claim 1, wherein the sector of the beam pattern inhibited by the interrupter corresponds to a sector angle of between about two degrees (2°) to about ten degrees (10°).

4. The electromagnetic antenna of claim 1 wherein the radiator has a length dimension corresponding to approximately ¼(λ) wherein the λ wavelength of the average wavelength transmitted/received by the antenna system.

5. The electromagnetic antenna of claim 1 wherein the ground plane defines a substantially circular disc having an axis of symmetry normal to the plane of the disc, and wherein the interrupter defines an arcuate strip having one end electrically mounting to an edge of the circular disc and the other end is proximal to the axis.

6. The electromagnetic antenna of claim 1 wherein the interrupter defines a substantially convex shape.

7. The electromagnetic antenna of claim 1 further comprising a radome fabricated from a radar transparent material disposed over the radiator and mounted to the ground plane, wherein the interrupter is integrated within the radar transparent radome material.

8. The electromagnetic antenna of claim 7 wherein the ground plane defines a substantially circular disc having an axis of symmetry normal to the plane of the circular disc and wherein the radome is rotatable about the axis of symmetry.

9. The electromagnetic antenna of claim 1 comprising a plurality of interrupters each electrically connected to the conductive ground plane, each of the plurality of interrupters inhibiting the transmission of a portion of the beam pattern.

10. The electromagnetic antenna of claim 9 wherein the interrupters are positionable about an axis of symmetry such that the sectors inhibited by the interrupters are one of either additive and overlapping.

11. A method of controlling an electromagnetic antenna, comprising:
operating a Radio Frequency (RF) radiator by transmitting and receiving Electromagnetic Energy (EME) energy about a conductive ground plane;
sensing a beam pattern produced by the radiator about an axis of symmetry normal to the conductive ground plane, the beam pattern indicative of the performance of the radiator's signal strength;
interrupting the Electromagnetic Energy (EME) transmitted/received within a sector of the beam pattern.

12. The method of controlling an electromagnetic antenna of claim 11, wherein the sector of the beam pattern interrupted corresponds to a sector angle of between about one degree (1°) to about twenty degrees (20°).

13. The method of controlling an electromagnetic antenna of claim 11 wherein the sector of the beam pattern interrupted corresponds to a sector angle of between about two degrees (2°) to about ten degrees (10°).

14. The method of controlling an electromagnetic antenna of claim 11 wherein the radiator has a length dimension corresponding to approximately ¼(λ) wherein λ is the wavelength of the average wavelength transmitted/received by the antenna system.

15. The method of controlling an electromagnetic antenna of claim 11 wherein the ground plane defines a substantially circular disc, and wherein the interrupter defines an conductive strip having one end electrically mounting to an edge of the circular disc and the other end is proximal to the axis.

16. The method of controlling an electromagnetic antenna of claim 11 wherein the interrupter defines a substantially arcuate shape.

17. The method of controlling an electromagnetic antenna of claim 15 further comprising the step of: integrating the conductive strip within an electrically transparent radome disposed over the radiator and connecting an end of the strip to the conductive ground plane.

18. The method of controlling an electromagnetic antenna of claim 15 further comprising the step of: rotating the radome about the axis of symmetry.

19. The method of controlling an electromagnetic antenna of claim 15 wherein step of sensing the beam pattern about the axis of symmetry further comprising the step of sensing sectors corresponding to a high electromagnetic energy transmission and sectors of low electromagnetic energy transmission, and wherein the interrupter is aligned along a radial corresponding to a sector having a low electromagnetic energy transmission.

20. The method of controlling an electromagnetic antenna of claim 19 wherein step of aligning the interrupter further comprises the step of: sensing changes in the strength of the energy transmission along radials of the axis of symmetry and dynamically changing the angular position of the interrupter to be aligned with radials of decreased strength.
